(19) United States
(12) Patent Application Publication
(10) Pub. No.: US 2026/0184641 A1
(43) Pub. Date: Jul. 2, 2026

(54) CHROMIUM OXIDE REFRACTORY OBJECT AND METHODS OF FORMING THEREOF

(71) Applicant: SAINT-GOBAIN CERAMICS & PLASTICS, INC., Worcester, MA (US)

(72) Inventors: Darren ROGERS, Worcester, MA (US); Damien Bolore, L'Isle-Sur-La-Sorgue (FR); Olivier Citti, Villeneuve les Avignon (FR); Bola Yoon, Marlborough, MA (US); Kristen E. Pappacena, Westborough, MA (US)

(21) Appl. No.: 19/426,429

(22) Filed: Dec. 19, 2025

Related U.S. Application Data
(60) Provisional application No. 63/740,486, filed on Dec. 31, 2024.

(51) Int. Cl. C04B 35/12; C04B 38/00

(52) U.S. Cl. CPC C04B 35/12; C04B 38/0054; C04B 38/0061; C04B 2235/3232; C04B 2235/3241; C04B 2235/3244; C04B 2235/9607

(57) ABSTRACT

A refractory object may include a body including a ceramic material and a total porosity of at most 30 vol % for a total volume of the body. The body may include at most 16 vol % of open porosity for the total volume of the body or permeability of less than 9.6 mD. The body may have Modulus of Rupture (MOR) of at least 20 MPa, a thermal shock resistance of at least 6 cycles, or a combination thereof.

### CROSS-REFERENCE TO RELATED APPLICATION(S)

This application claims priority under 35 U.S.C. § 119(e) to U.S. Provisional Application No. 63/740,486, entitled “CHROMIUM OXIDE REFRACTORY OBJECT AND METHODS OF FORMING THEREOF,” by Darren ROGERS et al., filed Dec. 31, 2024, which is incorporated herein by reference in its entirety.

### FIELD OF THE DISCLOSURE

The following is directed generally to a chromium oxide refractory object and methods of forming a chromium oxide refractory object. More particularly, the following is directed to a chromium oxide refractory block that can be used as sidewall blocks or as glass delivery blocks (i.e., flow blocks or bushing blocks).

### BACKGROUND

Refractory articles, such as sintered products produced from certain oxides, are used in glass furnaces. For example, refractory articles produced using chromium oxide are used when melting glass intended for the manufacture of glass fibers. Exposures to severe temperature gradients cause wear of refractory materials or complete failure of parts formed from refractory materials due to thermo-mechanical stress. The current development of very high-quality glasses combined with the need for improved sintered products increases the demand for improved refractory products in glass furnaces. Accordingly, the industry continues to demand improved manufacture of refractory articles and refractory articles having improved performance.

### BRIEF DESCRIPTION OF THE DRAWINGS

The present disclosure may be better understood, and its numerous features and advantages made apparent to those skilled in the art by referencing the accompanying drawings.

Embodiments are illustrated by way of example and are not limited in the accompanying figures.

FIG. 1 includes a flow chart illustrating a process of forming a refractory article in accordance with an embodiment.

FIG. 2 includes an illustration of a green body according to an embodiment.

FIG. 3 includes an illustration of a screw according to an embodiment.

FIG. 4 includes a plot of shear rate vs. viscosity of paste samples according to embodiments.

FIGS. 5-6 include images of green bodies made with different paste samples.

FIG. 7 includes a microscope image of a cross section of a refractory sample.

FIG. 8 includes a microscope image of a cross section of another refractory sample.

FIG. 9 includes a microscope image of a cross section of a refractory sample according to an embodiment.

FIG. 10 includes images of paste samples.

FIGS. 11-12 include images of additional paste samples.

FIG. 13 includes a plot of shear rate vs. viscosity of refractory samples.

FIG. 14 includes a plot of log D vs. cumulative vol for determining permeability and effective pore length.

FIG. 15 includes a plot for determining effective pore length as described herein.

FIGS. 16A and 16B include illustrations of images of refractory samples.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description, in combination with the figures, is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having”, or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

The following is generally directed to a refractory article including a ceramic material and a particular porosity and a method of forming the refractory article. Examples of the ceramic materials may include one or more oxides, carbides, nitrides, oxynitrides, or the like, or any combination thereof. Certain embodiments may relate to a refractory article having a chromium oxide body. According to embodiments described herein, a chromium oxide body may be defined as any body where a primary constituent of the body is a chromium oxide material.

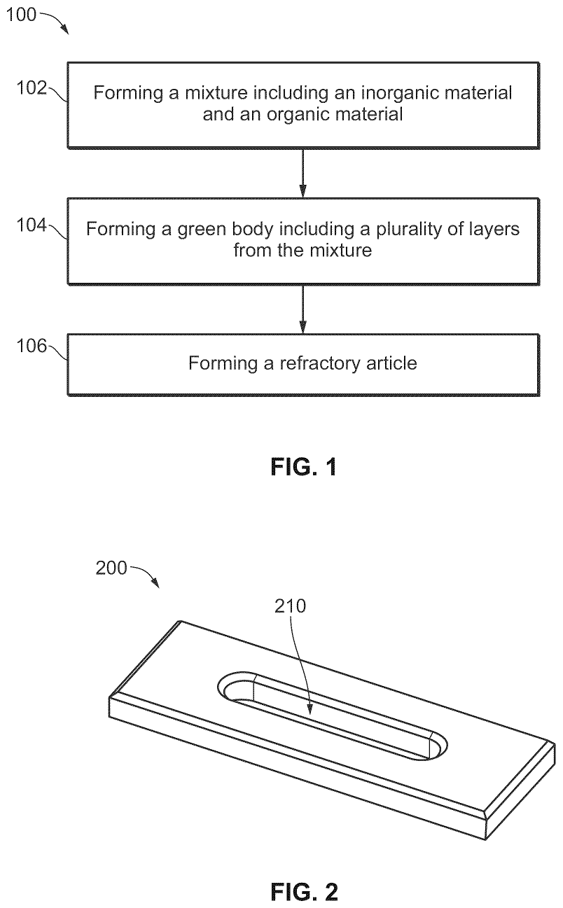

FIG. 1 includes a flowchart illustrating a process 100 for forming a refractory article. In an embodiment, the process 100 may include providing a forming composition and forming the forming composition into the refractory article. In an embodiment, the forming composition may include a mixture formed with powder material and liquid material that can be used in forming the refractory article.

The process 100 may start at block 102, including forming the mixture including an organic material, an inorganic material, or a combination thereof. In an embodiment, the mixture may include material powder including an organic material, an inorganic material, or any combination thereof. In an embodiment, the inorganic material may include a ceramic material and/or a ceramic-forming material. A ceramic-forming material is intended to refer to a material that may be treated, e.g., heated, and formed into a ceramic material. An exemplary ceramic-forming material may include a glassy material. In a particular embodiment, the ceramic and/or ceramic-forming material may include one or more metal oxide, such as chromium oxide (Cr₂O₃), titanium oxide (TiO₂), alumina (Al₂O₃), silica (SiO₂), zirconium oxide (ZrO₂), zircon (ZrSiO₄), tin oxide (SnO₂) or another metal oxide, or any combination thereof. In at least one embodiment, material powder may initially include an unprocessed raw material, for example, unprocessed Cr₂O₃ material, unprocessed Al₂O₃ material, unprocessed SiO₂ material, and unprocessed TiO₂ material. In another embodiment, material powder may include a dispersant, a binder material, an additive such as sintering aids, a thickener, or the like, or any combination thereof.

In an embodiment, the mixture may include liquid material including an organic material, an inorganic material, or any combination thereof. For example, liquid material may include solvent, such as water, alcohol, isopropyl alcohol, or another suitable organic or inorganic material that may facilitate formation of the mixture with suitable processibility for forming the refractory article. In another example, liquid material may include a binder material, a dispersant material, or another additive, or any combination thereof.

In an embodiment, the mixture may include a dispersant that may facilitate improved formation and/or properties of the mixture. A suitable dispersant may include an inorganic material, an organic material including a polymer, oligomer, monomer, or any combination thereof, or a combination thereof. Dispersant may be powder or liquid. In a particular example, dispersant may include powder material.

In an embodiment, a suitable dispersant may include a water reducer, a retarder, a plasticizer, a superplasticizer, or any combination thereof. In a further embodiment, a dispersant may include a material including hydroxylic acid, lignin, lignosulfonates, phosphate-based material, calcium chloride, calcium nitrate, sodium nitrate, sugar, sucrose, sodium gluconate, glucose, citric acid, tartaric acid, or any combination thereof. In a particular embodiment, a suitable dispersant may include a water-reducing admixture. A particular, suitable example may include a polycarboxylate-based dispersing agent. In another particular example, powder dispersant may be used to form the mixture.

In an embodiment, the mixture may include a particular content of dispersant that may facilitate improved formation and/or properties of the mixture. For example, the mixture may include at least 2.0 vol % of dispersant for the total volume of the mixture, such as at least 2.4 vol %, at least 2.8 vol %, at least 3.2 vol %, at least 3.5 vol %, at least 3.8 vol %, at least 4.0 vol %, at least 4.3 vol %, at least 4.6 vol %, at least 4.8 vol %, at least 5.0 vol %, at least 5.2 vol %, or at least 5.5 vol % for the total volume of the mixture. In another example, the content of dispersant may be at most 7.0 vol % for the total volume of the mixture, such as at most 6.7 vol %, at most 6.5 vol %, at most 6.3 vol %, at most 6.0 vol %, at most 5.7 vol %, or at most 5.5 vol %. In a further example, the content of dispersant may be in a range including any of the minimum and maximum percentages noted herein. In a particular example, the mixture may include a content of dispersant in a range from 2.0 vol % to 7.0 vol % or in a range from 3.8 vol % to 6.0 vol % for the total volume of the mixture.

In another embodiment, the mixture may include a binder material that may facilitate improved and/or properties of the mixture. An exemplary binder material may include an organic material, such as a polymer, oligomer, monomer, or the like, or any combination thereof. In a particular embodiment, the binder material may include a hydrophilic polymer. For example, a suitable binder may include polyvinyl alcohol, polyethylene glycol, or any combination thereof. A particular example of polyethylene glycol may have a molecular weight of at least 4000 g/mol or higher, such as 7000-9000 g/mol.

In another embodiment, the mixture may include a particular content of a binder material that may facilitate improved formation and/or properties of the mixture. For example, the mixture may include at least 2.5 vol % of a binder material for the total volume of the mixture, such as at least 2.7 vol %, at least 3.2 vol %, at least 3.5 vol %, at least 3.8 vol %, at least 4.0 vol %, at least 4.3 vol %, at least 4.6 vol %, at least 4.8 vol %, at least 5.0 vol %, at least 5.2 vol %, at least 5.5 vol %, at least 5.8 vol %, at least 6.0 vol %, at least 6.3 vol %, or at least 6.5 vol % for the total volume of the mixture. In another example, the content of a binder material may be at most 8.0 vol % for the total volume of the mixture, such as at most 7.7 vol %, at most 7.5 vol %, at most 7.3 vol %, at most 7.0 vol %, at most 6.7 vol %, or at most 6.5 vol % for the total volume of the mixture. In a further example, the content of dispersant may be in a range including any of the minimum and maximum percentages noted herein. In a particular example, the mixture may include a content of dispersant in a range from 2.5 vol % to 8.0 vol % or in a range from 4.8 vol % to 7.0 vol % for the total volume of the mixture.

In an embodiment, the mixture may include a particular content of solvent that may facilitate improved formation and/or properties of the mixture. For example, the mixture may include at least 5 vol % of solvent for the total volume of the mixture, such as at least 8 vol %, at least 9 vol %, at least 10 vol %, at least 11 vol %, at least 12 vol %, or at least 14 vol % of solvent for the total volume of the mixture. In another example, the mixture may include a solvent in the content of at most 15 vol %, at most 13 vol %, at most 12 vol %, at most 11 vol %, at most 10 vol %, or at most 9 vol % for the total volume of the mixture. Moreover, the content of a solvent may be in a range including any of the minimum and maximum percentages noted herein.

In an embodiment, forming the mixture may include forming a mixture including particles having a particular particle size. In an example, the ceramic and/or ceramic-forming material may include a wide particle size distribution, such as including particles of submicron sizes spanning up to 500 microns or even 1 mm. In another example, ceramic and/or ceramic-forming material may have a multi-modal distribution including particles having sizes from 1 to 50 microns, such as bimodal distribution. In still another embodiment, the ceramic and/or ceramic-forming material may include a particular average particle size that may facilitate improved formation and/or properties of the mixture. In an example, the ceramic and/or ceramic-forming material may include particles having an average particle size at least 10 microns, at least 15 microns, at least 20 microns, at least 25 microns, at least 30 microns, at least 40 microns, at least 50 microns, at least 55 microns or at least 60 microns. In another example, the inorganic material may include particles having an average particle size of at most 65 microns, at most 60 microns, at most 55 microns, at most 50 microns, at most 45 microns, at most 40 microns, at most 35 microns, at most 30 microns, or at most 25 microns. In a particular example, the mixture may include particles of ceramic and/or ceramic-forming material having an average particle size in a range from 10 microns to 65 microns or in a range from 20 microns to 60 microns. In a further embodiment, raw material powder may be sieved to have the particle sizes described in embodiments herein before being mixed with another material.

Providing the forming composition may include combining or mixing the raw material and any additive by a suitable method. For example, mixing may be facilitated with a mixing device. In an embodiment, high shear mixer may be used to improve formation of the mixture. In a further embodiment, mixing may include using a stirring device at a stirrer speed of 4 to 80 rpm, an orbital mixing at an orbital speed of 4 to 69 rpm, a motor mixer having a horse power of 2 or more, or any combination thereof. In another embodiment, mixing may be performed using ½ HP large Hobart mixer, Resodyn speed mixer, or the like, or any combination thereof.

In a further embodiment, mixing may be performed in a particular order that may facilitate improved formation of the mixture. In an example, dispersant may be mixed with a ceramic material and/or ceramic-forming material before another component, such as a binder material and/or solvent, may be added.

In a further embodiment, the mixture may include a particular solid loading that may facilitate improved formation and/or performance and/or properties of the refractory article. For example, the solid loading may be particularly suited for further processing of the mixture. In a particular embodiment, the mixture may include a solid loading of less than 76 vol % or less than 74.5 vol % for the volume of the mixture, such as at most 74 vol %, at most 73 vol %, or at most 72 vol % for the total volume of the mixture. Additionally or alternatively, the mixture may include a solid loading of at least 55 vol % for the total volume of the mixture, such as at least 58 vol %, at least 62 vol %, at least 65 vol %, at least 68 vol %, at least 70 vol %, at least 72 vol %, or at least 74 vol % for the total volume of the mixture. Moreover, the mixture may include a solid loading including any of the minimum and maximum percentages noted herein.

In another embodiment, the mixture may include a particular viscosity that may facilitate improved formation and/or performance and/or properties of the refractory article. In a particular embodiment, the mixture may demonstrate a shear thinning behavior. In a further embodiment, the mixture may include a viscosity of at least 10 Pa·S to at most 1000 Pa·S at a shear rate from 1 s⁻¹ to 100 s⁻¹ or at least 10 Pa·S to at most 800 Pa·S or at least 10 Pa·S to at most 500 Pa·S or at least 20 Pa·S to at most 500 Pa·S. In this disclosure, viscosity is determined according to the vane-in-cup rheology measurement.

In a further embodiment, the mixture may include a viscosity at a shear rate of 1 s⁻¹ of at least 20 Pa·S, such as at least 30 Pa·S, at least 50 Pa·S, at least 60 Pa·S, at least 70 Pa·S, at least 80 Pa·S, at least 90 Pa·S, or at least 100 Pa·S. Alternatively or additionally, the mixture may include a viscosity at a shear rate of 1 s⁻¹ of at most 1000 Pa·S, at most 900 Pa·S, at most 800 Pa·S, at most 700 Pa·S, at most 600 Pa·S, or at most 500 Pa·S. Moreover, the mixture may include a viscosity at a shear rate of 1 s⁻¹ in a range including any of the minimum and maximum values noted herein.

In a further embodiment, the mixture may include a viscosity at a shear rate of 10 s⁻¹ of at least 10 Pa·S, at least 15 Pa·S, at least 20 Pa·S, at least 25 Pa·S, at least 30 Pa·S, at least 35 Pa·S, at least 40 Pa·S, or at least 45 Pa·S. Alternatively or additionally, the mixture may include a viscosity at a shear rate of 10 s⁻¹ of at most 500 Pa·S, at most 400 Pa·S, at most 300 Pa·S, at most 200 Pa·S, at most 100 Pa·S, at most 90 Pa·S, or at most 80 Pa·S. Moreover, the mixture may include a viscosity at a shear rate of 10 s⁻¹ in a range including any of the minimum and maximum values noted herein.

In a further embodiment, the mixture may include a viscosity at a shear rate of 100 s⁻¹ of at least 10 Pa·S, at least 15 Pa·S, at least 20 Pa·S, at least 25 Pa·S, or at least 30 Pa·S. Alternatively or additionally, the mixture may include a viscosity at a shear rate of 100 s⁻¹ of at most 100 Pa·S, at most 90 Pa·S, at most 80 Pa·S, at most 70 Pa·S, at most 50 Pa·S, at most 40 Pa·S, or at most 30 Pa·S. Moreover, the mixture may include a viscosity at a shear rate of 100 s⁻¹ in a range including any of the minimum and maximum values noted herein.

It is worth noting the mixture may be formed having properties that may facilitate improved formation of a green body. For example, the mixture of embodiments herein may have improved shape retention when formed into the green body. In another example, the mixture may have improved rheology and/or processability, such as extrudability, that may be particularly suited for the process of embodiments herein to form a green body.

After forming, the mixture may be transferred to a container for further processing. In an example, the mixture may be placed into a pressurized tank. In a more particular example, a maximum pressure of 8 bar may be applied to the mixture to facilitate further processing of the mixture.

The process 100 may continue at block 104, including forming a green body from the mixture. In another embodiment, forming the green body may include moving the mixture through a barrel containing a screw. In a particular embodiment, the screw may be configured to facilitate extrusion of the mixture of embodiments herein and formation of the refractory article with improved microstructure and/or performance. For instance, the screw may be configured to apply a higher torque that may facilitate extrusion of a mixture having a relatively higher viscosity. In a further example, the screw may be configured to improve homogeneity of the mixture, reduce formation of bubbles and/or the size of bubbles in the mixture, or any combination thereof.

In an embodiment, forming the green body may include extruding at least a portion of the mixture. In a further embodiment, performing the extrusion may involve using a single screw extruder, wherein the screw may have variable bore thickness. In another embodiment, the screw may include a particular L/D ratio and/or a compression ratio that may facilitate improved formation of the green body and/or improved formation of the refractory article and/or performance thereof. In an embodiment, the screw may have an L/D ratio of at least 8, wherein L the flighted length of the screw and D is the nominal diameter of the screw. For example, the L/D ratio may be at least 8.5, at least 9, or at least 10. In another example, the L/D ratio may be at most 15, at most 14, at most 12, or at most 10. Moreover, the screw may have the L/D ratio in a range including any of the minimum and maximum values noted herein.

In an embodiment, the screw may have a compression ratio greater than 1.0, such as at least 1.3, at least 1.5, or greater than 1.5. In a particular example, the compression ratio may be at least 1.5, at least 1.8, or at least 2.0. Additionally or alternatively, the compression ratio may be not greater than 2.5, such as less than 2.5, at most 2.2, at most 2.0, or at most 1.8. Moreover, the screw may have the compression ratio in a range including any of the minimum and maximum values noted herein. As used herein, the compression ratio is the ratio of the feed zone channel depth to the meter zone channel depth.

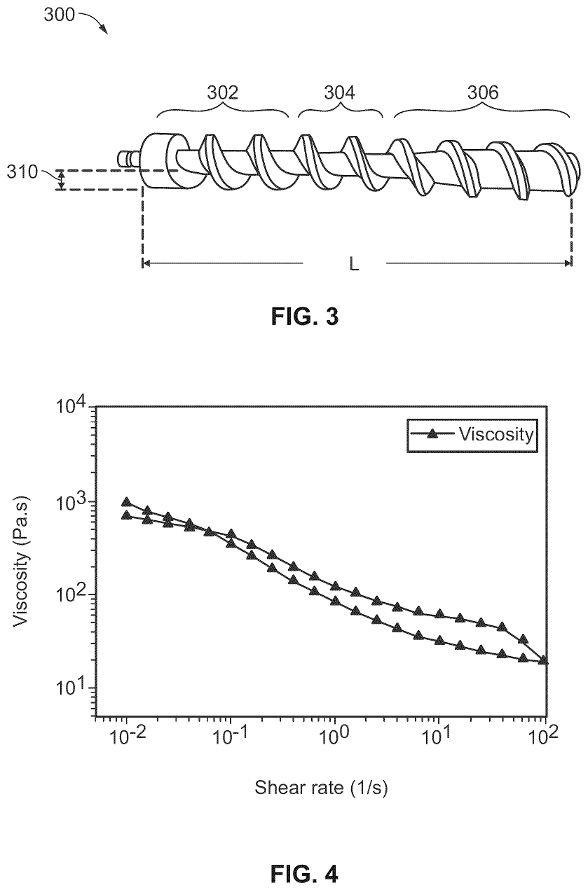

Referring to FIG. 3, an exemplary screw 300 of a particular embodiment is illustrated, including a feed zone 302, a transition zone 304, a meter zone 306, and a flighted length L. A channel depth 310 is illustrated for the feed zone 302. As illustrated, the meter zone 306 may have a greater bore thickness than the transition zone that may have a greater bore thickness than the feed zone.

In a further embodiment, forming the green body comprises extruding at a particular shear rate that may facilitate improved formation of the green body. For example, the shear rate may be at least 5 s⁻¹, such as at least 6 s⁻¹, at least 8 s⁻¹, at least 10 s⁻¹, at least 12 s⁻¹, at least 14 s⁻¹, at least 16 s⁻¹, or at least 18 s⁻¹. In another example, the shear rate may be at most 20 s⁻¹, such as at most 18 s⁻¹, at most 17 s⁻¹, at most 15 s⁻¹, at most 13 s⁻¹, at most 11 s⁻¹, at most 10 s⁻¹, at most 8 s⁻¹, at most 6 s⁻¹, or at most 4 s. Moreover, the shear rate may be in a range including any of the minimum and maximum values noted herein.

In an embodiment, extrusion may be performed at a certain pressure and/or a hold torque to facilitate extrusion of the mixture. For example, extrusion pressure may be from 0.2 to 0.8 MPa. In another example, a holding torque may be 1.0 Nm to 5.0 Nm. In a further embodiment, extrusion may be performed at room temperature (i.e., 22-25° C.).

Turning back to FIG. 1, the green body may include a plurality of layers, wherein each layer may include a portion of the mixture. In an embodiment, the process 100 may include forming the green body layer by layer with at least a portion of the extrudate. In a particular embodiment, the process 100 may include print a plurality of layers from the extrudate of the mixture. In a further embodiment, forming the green body may include directly printing the plurality of layers via the nozzle. It can be appreciated the nozzle size may vary to facilitate formation of green bodies of desirable sizes. For example, a suitable nozzle size may be at least 2 mm, such as 4 mm, 6 mm, 8 mm, or 10 mm, or even greater. In a further embodiment, the plurality of layers may have an average thickness of at least 1 mm, such as at least 2 mm, at least 3 mm, at least 4 mm, or at least 5 mm. Alternatively or additionally, the average layer thickness may be at most 10 mm, at most 8 mm, at most 5 mm, or at most 3 mm. In certain examples, the average layer thickness may be in a range including any of the minimum and maximum values noted herein.

In a particular embodiment, forming the green body may include an additive manufacturing process that is configured to form the green body from the mixture of embodiments herein. In another particular embodiment, the process 100 may include extruding the mixture and 3D printing the extrudate to form the green body of embodiments herein.

It is worth noting that the process of embodiments herein improves over a conventional additive manufacturing method involving paste extrusion and 3DP. In an aspect, the process 100 involves a screw extruder that is carefully adapted to facilitate improved extrusion and printing and may be particularly suited for processing a paste having a high solid loading. For example, the extruder can have a particular screw that improves over a screw utilized in conventional additive manufacturing paste extrusion and 3DP and facilitates formation of a body having improved microstructure, such as porosity, permeability, tortuosity, or any combination thereof, which may in turn facilitate improved thermal properties and performance of the refractory article. As discussed in embodiments herein, the screw may have a particular flighted length, variable bore thickness, channel depth, compression ratio, or any combination thereof. In another example, the feed zone of the screw may not be heated. In a further example, the screw may include mixing flights, a vacuum system, or a combination thereof to further facilitate improved uniformity of the mixture. In yet another example, the screw may allow improved compression of the paste, which may facilitate reduction in sizes of air bubbles and help avoid formation of air bubbles. In another aspect, the process 100 involves carefully controlling mixing, extruding, and/or printing parameters, such as pressure, mixing speed, torque, shear rates, printing speed, or the like, or any combination thereof. The improvement of process 100 over conventional additive manufacturing, such binder jetting and paste extrusion and 3D printing, allows formation of the refractory article of embodiments herein with improved microstructures, properties, and performance.

In an embodiment, forming the green body may include a certain printing speed that may facilitate improved formation of the green body. In an example, the printing speed may be 100 to 1000 mm/min. After reading this disclosure, printing speed may be selected according to nozzle size, paste viscosity, shear rate, or any combination thereof to form the green body having a desirable shape.

In an embodiment, forming the green body may be performed at a particular humidity that may facilitate improved formation of the green body and/or property of the refractory article. For example, forming the green body may be performed at humidity of at most 40%.

In an embodiment, the green body may have a particular porosity that may facilitate improved formation and/or property of the refractory article. For example, the green body may include at least 20 vol % to at most 35 vol % of porosity for the total volume of the green body. In a further embodiment, the green body may be a stand-alone body, defect-free, crack-free, or any combination thereof.

The shape of the green body can be rectilinear, cylindrical, spherical, ellipsoidal or nearly any other shape. In a particular embodiment, the green body can be in the shape of a rectilinear block referred to as a blank that can subsequently be machined to form a prism block, a flow block or a bushing block. In another particular embodiment, the green body may have at least one dimension larger than about 100 mm, such as, larger than about 200 mm, larger than about 300 mm, larger than about 400 mm, larger than about 500 mm, larger than about 600 mm, larger than about 700 mm or even larger than about 800 mm. In another embodiment, the green body can be structured in such a fashion to more closely match a final component, for example, a forming block, to limit post forming processes.

FIG. 2 illustrates an exemplary green body 200, which may be formed into a bushing according to an embodiment. The green body 200 can include an aperture 210. The aperture 210 can have different shapes or dimensions along the length of the green body 200. It can also be tapered along the thickness of the green body. Other shapes may be used to meet the needs or desires for a particular application.

In a further embodiment, the process 100 may include heating the green body to form the finally formed body of the refractory article. The green body can be heated in an oven, heater, furnace, or the like. The heating process can include an initial heating where moisture, a solvent, a binder material, or another volatile component is evaporated, organic material is vaporized, or any combination thereof. The initial heating can be conducted at a temperature in a range of approximately 100° C. to approximately 300° C. for a time period in a range of approximately 10 hours to approximately 200 hours. In one embodiment, following the initial heating, the green body can be sintered at a temperature of at least about 1400° C., such as, at least about 1450° C., at least about 1500° C. In another embodiment, following the initial heating, the green body can be sintered at a temperature of at most 1550° C. or even at most 1500° C. The green body can be sintered for a time period in a range of approximately 10 hours to approximately 100 hours to form the body.

In another embodiment, the oxygen content in the atmosphere of the furnace may be adjusted in order to limit the volatilization of chromium oxide during the sintering. For example, the partial pressure of oxygen (“pO₂”) of the atmosphere of the furnace may be not greater than 10⁻¹ atm., such as, not greater than 10⁻³ atm., not greater than 10⁻⁵ atm., not greater than 10⁻⁷ atm., not greater than 10⁻⁹ atm., not greater than 10⁻¹¹ atm., or even not greater than 10⁻¹³ atm.

Sintering can include heating the green body up to a sintering temperature at a particular heating rate for multiple time periods in a sintering cycle for a set duration and then cooling the sintered body at a particular cooling-rate.

According to one particular embodiment, the heating rate may be at least about 1° C./h, such as, at least about 3° C./h, at least about 5° C./h, at least about 8° C./h, at least about 10° C./h, at least about 13° C./h, at least about 15° C./h, at least about 18° C./h, at least about 20° C./h, at least about 23° C./h, at least about 25° C./h, at least about 28° C./h or even at least about 29° C./h. According to still other embodiments, the heating rate may be at most 30° C./h, such as, at most 27° C./h, at most 25° C./h, at most 22° C./h, at most 20° C./h, at most 17° C./h, at most 15° C./h, at most 12° C./h, at most 10° C./h, at most 7° C./h, at most 5° C./h or even at most 2° C./h. It will be appreciated that the heating rate may be any value between any of the minimum and maximum values noted above. It will be further appreciated that the heating rate may be any value within a range between any numerical values between the maximum and minimum values noted above.

According to still another embodiment, the duration of the sintering cycle may be at least about 15 days, such as, at least about 20 days, at least about 25 days, at least about 30 days, at least about 35 days, at least about 40 days, at least about 45 days, at least about 50 days, at least about 55 days, at least about 60 days, at least about 65 days, at least about 70 days, at least about 75 days, at least about 80 days or even at least about 85 days. Further, the sintering cycle duration may be at most 90 days, such as, at most 85 days, at most 80 days, at most 75 days, at most 70 days, at most 65 days, at most 60 days, at most 55 days, at most 50 days, at most 45 days, at most 40 days, at most 35 days, at most 30 days, at most 25 days or even at most 20 days. It will be appreciated that the sintering cycle may be any number of days between any of the minimum and maximum values noted above. It will be further appreciated that the sintering cycle may be any number of days within a range between any of the maximum and minimum values noted above.

According to one particular embodiment, the cooling rate may be at least about 1° C./h, such as, at least about 3° C./h, at least about 5° C./h, at least about 8° C./h, at least about 10° C./h, at least about 13° C./h, at least about 15° C./h, at least about 18° C./h, at least about 20° C./h, at least about 23° C./h, at least about 25° C./h, at least about 28° C./h or even at least about 29° C./h. According to still other embodiments, the heating rate may be at most 30° C./h, such as, at most 27° C./h, at most 25° C./h, at most 22° C./h, at most 20° C./h, at most 17° C./h, at most 15° C./h, at most 12° C./h, at most 10° C./h, at most 7° C./h, at most 5° C./h or even at most 2° C./h. It will be appreciated that the cooling rate may be any value between any of the minimum and maximum values noted above. It will be further appreciated that the cooling rate may be any value within a range between any numerical values between the maximum and minimum values noted above.

The shape of the body after sintering generally corresponds to the shape of the green body prior to sintering. Thus, the body may have any of the shapes as previously described with respect to the green body. In an embodiment, the shape and size of the sintered body may be near target dimensions. In certain instances, shrinkage may be considered between the sintered body and the target dimensions. For example, the sintered body may have a linear shrinkage of at most 25% compared to the targeted dimensions, such as at most 20%, or at most 18%. In one embodiment, grinding may be performed on the sintered body to finalize the appearance of the refractory article.

After sintering, the refractory article may be formed including a body having a particular composition, structure, dimension, microstructure, or any combination thereof that may facilitate improved performance for intended applications.

In a particular embodiment, the refractory article may include a bushing block or a forming block. In an example, the refractory article may be particularly suited for applications involving harsh conditions, such as high temperatures (e.g., at least 1100° C.). In another example, the refractory article may be placed in glass forming temperatures, e.g., from 1100-1400° C., or in contact with molten glass, which typically has temperatures of 1400-1600° C., or other similar conditions, or any combination thereof. In a further example, a bushing block or a forming block formed by the process described in embodiments herein may have improved performance when used in glass manufacturing, and in particular, glass fiber production. The bushing block or forming block may be light weighting and have improved thermal properties, such as thermal shock resistance, damage tolerance, glass penetration resistance, or the like, or any combination thereof, compared to a conventionally made bushing block, such as using isopressing (i.e., cold isostatic pressing). Moreover, the process of embodiments herein may allow manufacturing of bushing block with significantly reduced time and cost. For example, the isopressing process may require a significant machining and slot milling of the sintered body to have the final shape and dimensions to suit applications in glass manufacturing while finishing of the sintered body made by the process described in embodiments herein may be optional or minimized.

In an embodiment, the body may include a particular composition that may be suited for the intended applications. In another embodiment, the body may include a ceramic material including a metal oxide. In certain instances, the ceramic material may consist essentially of one or more metal oxides. In another example, the ceramic material may include chromium oxide, mullite, alumina, zircon, zirconium oxide, or any combination thereof. In a particular example, the ceramic material may include chromium oxide having particle sizes from 1 micron to 500 microns.

In a particular embodiment, the body may include a primary constituent comprising an oxide, such as chromium oxide, mullite, alumina, zircon, zirconium oxide, or the like, or a more complex compound including an oxide constituent. In another embodiment, the primary constituent may be in a content of at least 50 wt. % for a total weight of the body, at least 55 wt. %, at least 60 wt. %, at least 65 wt. %, at least 70 wt. %, at least 75 wt. %, at least 80 wt. %, at least 85 wt. %, at least 85 wt. %, at least 90 wt. %, at least 92 wt. %, at least 95 wt. %, or at least 98 wt. % for the total weight of the body. Alternatively or additionally, the primary constituent may be at most 99.5 wt. % for the total weight of the body, at most 99 wt. %, at most 98 wt. %, at most 95 wt. %, at most 93 wt. %, at most 90 wt. %, at most 85 wt. %, at most 80 wt. %, at least 75 wt. %, at most 70 wt. %, at most 65 wt. %, at most 60 wt. %, or at most 55 wt. % for the total weight of the body. In an example, the content of the primary constituent may be in a range including any of the minimum and maximum percentages noted herein, for example, the body may include a primary constituent of up to 99.5 wt. % or up to 98 wt. % for the total weight of the body.

In an embodiment, the body may include an additive in a minor content. An exemplary additive may include titanium oxide, zirconium oxide, magnesium oxide, or any combination thereof. In a further example, the additive may be at least 0.5 wt. % for a total weight of the body, such as at least 1 wt. %, at least 2 wt. %, or at least 4 wt. % for the total weight of the body. In another example, the additive may be at most 5 wt. % for the total weight of the body, at most 4 wt. %, at most 3 wt. %, at most 2 wt. %, at most 1 wt. %, or at most 0.5 wt. % for the total weight of the body. Moreover, the content of the additive may be in a range including any of the minimum and maximum percentages noted herein.

In an embodiment, the body may include a primary constituent including chromium oxide (also referred to as chromia or Cr₂O₃ in this disclosure) and optionally may include an additive including zirconia, titania, magnesia, or a combination thereof. In another embodiment, the body may have a particular content of Cr₂O₃ that may facilitate improved performance of the refractory article. For example, the content Cr₂O₃ may be at least 55 wt. % for the total weight of the body, such as, at least 60 wt. %, at least 65 wt. %, at least 70 wt. %, at least 75 wt. %, at least 80 wt. %, at least 83 wt. %, at least 85 wt. %, at least 88 wt. %, at least 90 wt. %, at least 93 wt. % or even at least 95 wt. %. In another example the content of Cr₂O₃ may be at most 98 wt. %, such as, at most 97.5 wt. %, at most 97 wt. %, at most 96.5 wt. %, at most 96 wt. %, at most 95 wt. %, at most 90 wt. %, at most 85 wt. %, at most 80 wt. %, at most 75 wt. %, at most 70 wt. %, or at most 65 wt. % for the total weight of the body. It will be appreciated that the content of Cr₂O₃ may be any value between any of the minimum and maximum values noted above. It will be further appreciated that the content of Cr₂O₃ may be within a range including any of the minimum and maximum values noted above.

According to yet another embodiment, the body may include a primary constituent of zircon and optionally an additive, such as one or more oxides selected from titanium oxide, zirconium oxide, magnesium oxide, chromium oxide, or any combination thereof. In an example, the content of zircon (ZrSiO₄) may be at least 55 wt. % for the total weight of the body, at least 60 wt. %, at least 65 wt. %, at least 70 wt. %, at least 75 wt. %, at least 80 wt. %, at least 83 wt. %, at least 88 wt. %, at least 90 wt. %, at least 93 wt. %, or at least 96 wt. % for the total weight of the body. In another example, the content of zircon may be at most 99.5 wt. % for the total weight of the body, at most 98 wt. %, at most 95 wt. %, at most 90 wt. %, at most 85 wt. %, at most 80 wt. %, at most 75 wt. %, at most 70 wt. %, or at most 65 wt. % for the total weight of the body. It will be appreciated that the content of zircon may be any value between any of the minimum and maximum values noted above. It will be further appreciated that the content of zircon may be within a range including any of the minimum and maximum values noted above.

In an embodiment, the body may include a primary constituent of alumina (Al₂O₃). In another embodiment, the body may include a minor content of Al₂O₃. For example, the content of Al₂O₃ may be at least about 0.7 wt. % for the total weight of the body, such as, at least about 1.0 wt. %, at least about 1.3 wt. %, at least about 1.5 wt. %, at least about 1.8 wt. %, at least about 2.0 wt. %, at least about 2.3 wt. %, at least about 2.5 wt. %, at least about 2.8 wt. %, at least about 3.0 wt. %, at least about 3.3 wt. %, at least about 3.5 wt. %, at least about 3.8 wt. % or even at least about 4.0 wt. % for the total weight of the body. In another example, the Al₂O₃ content may be at most 10 wt. % for the total weight of the body, such as, at most 9.7 wt. %, at most 9.5 wt. %, at most 9.2 wt. %, at most 9.0 wt. %, at most 8.7 wt. %, at most 8.5 wt. %, at most 8.2 wt. %, at most 8.0 wt. %, at most 7.7 wt. %, at most 7.5 wt. %, at most 7.2 wt. %, at most 7.0 wt. %, at most 6.7 wt. %, at most 6.5 wt. %, at most 6.2 wt. % or even at most 6.0 wt. % for the total weight of the body. It will be appreciated that the Al₂O₃ content may be any value between any of the minimum and maximum values noted above. It will be further appreciated that the Al₂O₃ content may be within a range between any of the minimum and maximum values noted above.

In another embodiment, the body may have a particular SiO₂ content for the total weight of the body. For example, the SiO₂ content may be at least about 0.3 wt. % for the total weight of the body, such as, at least about 0.5 wt. %, at least about 0.8 wt. %, at least about 1.0 wt. %, at least about 1.3 wt. %, at least about 1.5 wt. %, at least about 1.8 wt. %, at least about 2.0 wt. %, at least about 2.3 wt. % or even at least about 2.5 wt. % for the total weight of the body. In another example, the SiO₂ content may be at most 5 wt. % for the total weight of the body, such as, at most 4.7 wt. %, at most 4.5 wt. %, at most 4.2 wt. %, at most 4.0 wt. %, at most 3.7 wt. %, at most 3.5 wt. %, at most 3.2 wt. %, at most 3.0 wt. % or even at most 2.7 wt. % for the total weight of the body. It will be appreciated that the SiO₂ content may be any value between any of the minimum and maximum values noted above. It will be further appreciated that the body may include a SiO₂ content within a range between any of the minimum and maximum values noted above.

According to yet another embodiment, the body may include a primary constituent of mullite. In another embodiment, the body may include a minor content of mullite. For example, the mullite content may be at least about 0.7 wt. % for the total weight of the body, such as, at least about 1.0 wt. %, at least about 1.3 wt. %, at least about 1.5 wt. %, at least about 1.8 wt. %, at least about 2.0 wt. %, at least about 2.3 wt. %, at least about 2.5 wt. %, at least about 2.8 wt. %, at least about 3.0 wt. %, at least about 3.3 wt. %, at least about 3.5 wt. %, at least about 3.8 wt. % or even at least about 4.0 wt. % for the total weight of the body. In another example, the mullite content may be at most 10 wt. % for the total weight of the body, such as, at most 9.7 wt. %, at most 9.5 wt. %, at most 9.2 wt. %, at most 9.0 wt. %, at most 8.7 wt. %, at most 8.5 wt. %, at most 8.2 wt. %, at most 8.0 wt. %, at most 7.7 wt. %, at most 7.5 wt. %, at most 7.2 wt. %, at most 7.0 wt. %, at most 6.7 wt. %, at most 6.5 wt. %, at most 6.2 wt. % or even at most 6.0 wt. % for the total weight of the body. It will be appreciated that the mullite content may be any value between any of the minimum and maximum values noted above. It will be further appreciated that the body may have a mullite content within a range between any of the minimum and maximum values noted above.

In another embodiment, the body may include a minor content of TiO₂ content. For example, the body may have a TiO₂ content of at least about 0.3 wt. % for the total weight of the body, such as, at least about 0.5 wt. %, at least about 0.8 wt. %, at least about 1.2 wt. %, at least about 1.5 wt. %, at least about 1.7 wt. %, or even at least about 2.0 wt. %. In another example, the TiO₂ content may be at most 5.6 wt. %, such as, at most 5.2 wt. %, at most 4.7 wt. %, at most 4.2 wt. %, at most 3.7 wt. %, at most 3.2 wt. %, at most 2.6 wt. %, at most 2.0 wt. %, or at most 1.8 wt. % for the total weight of the body. It will be appreciated that the TiO₂ content may be any value between any of the minimum and maximum values noted above. It will be further appreciated that the body may have a TiO₂ content within a range between any of the minimum and maximum values noted above.

According to yet another embodiment, the body may have a particular MgO content of a total weight of the body. For example, the MgO content may be at least about 0.1 wt. % for the total weight of the body, such as, at least about 0.2 wt. %, at least about 0.3 wt. %, at least about 0.4 wt. %, at least about 0.5 wt. %, at least about 0.6 wt. % or even at least about 0.7 wt. % for the total weight of the body. In another example, the MgO content may be at most 2.0 wt. % for the total weight of the body, such as, at most 1.8 wt. %, at most 1.3 wt. %, or even at most 0.8 wt. % for the total weight of the body. It will be appreciated that the MgO content may be any value between any of the minimum and maximum values noted above. It will be further appreciated that the body may have a MgO content within a range between any of the minimum and maximum values noted above.

In an embodiment, the body may include a primary constituent of ZrO₂. According to yet another embodiment, the body may have a minor content of ZrO₂ of a total weight of the body. For example, the body may have a ZrO₂ content of at least about 0.1 wt. % for the total weight of the body, such as, at least about 0.3 wt. %, at least about 0.5 wt. %, at least about 0.8 wt. %, at least about 1.0 wt. %, at least about 1.3 wt. %, at least about 1.5 wt. %, at least about 1.8 wt. %, at least about 2.0 wt. %, at least about 2.3 wt. %, at least about 2.5 wt. %, at least about 2.8 wt. %, at least about 3.0 wt. %, at least about 3.3 wt. %, at least about 3.5 wt. %, at least about 3.8 wt. %, at least about 4.0 wt. %, at least about 4.3 wt. %, at least about 4.5 wt. %, at least about 4.8 wt. % or even at least about 5.0 wt. % for the total weight of the body. In another embodiment, the body may have a ZrO₂ content of at most 10 wt. % for the total weight of the body, such as, at most 9.7 wt. %, at most 9.5 wt. %, at most 9.2 wt. %, at most 9.0 wt. %, at most 8.7 wt. %, at most 8.5 wt. %, at most 8.2 wt. %, at most 8.0 wt. %, at most 7.7 wt. %, at most 7.5 wt. %, at most 7.2 wt. %, at most 7.0 wt. %, at most 6.7 wt. %, at most 6.5 wt. %, at most 6.0 wt. %, at most 5.7 wt. %, at most 5.5 wt. % or even at most 5.2 wt. %. It will be appreciated that the body may have a ZrO₂ content of any value between any of the minimum and maximum values noted above. It will be further appreciated that the body may have a ZrO₂ content within a range between any of the minimum and maximum values noted above.

According to still another embodiment, the body may include a minor content of Fe₂O₃, one or more alkaline earth metal oxides, one or more alkali metal oxides, HfO₂, MnO₂, NiO, one or more rare earth oxides, V₂O₅, a transition metal oxide that is not expressly disclosed herein, or any combination thereof. For example, the body may include a minimal content of each of the oxide noted above or a minimum total content of the oxides noted above. In a further example, such content may be at most 2.0 wt. %, such as, at most 1.0 wt. %, at most 0.8 wt. %, at most 0.5 wt. %, at most 0.4 wt. %, at most 0.3 wt. %, at most 0.2 wt. % or even at most 0.1 wt. %. According to still another embodiment the body may be essentially free of any of the metal oxide noted above.

In an embodiment, a refractory article formed according to the process described in embodiments herein may have a particular density, porosity (vol %), percentage of number of certain pores, pore types, pore sizes, or any combination thereof that may facilitate improved properties and performance of the refractory article.

The body may have particular density. In an embodiment, the body may have particular Archimedes bulk density that may facilitate improved performance of the refractory article. Archimedes bulk density may be measured using Archimedes' Principle. For example, the body may have Archimedes Bulk density of at least 3.8 g/cm³, at least 3.9 g/cm³, at least 4.0 g/cm³, at least 4.2 g/cm³, or at least 4.3 g/cm³. In another example, the body may include Archimedes Bulk density of at most 4.8 g/cm³, such as at most 4.7 g/cm³, at most 4.5 g/cm³, at most 4.4 g/cm³, or at most 4.3 g/cm³. Refractory object may have a density of at most 4.8 g/cm³, such as, at most 4.7 g/cm³ or even at most 4.6 g/cm³. It will be appreciated that the body may have Archimedes bulk density of any value between any of the minimum and maximum values noted above. It will be further appreciated that the body may have Archimedes bulk density within a range between any of the minimum and maximum values noted above.

In a further embodiment, the body may have a particular relative density that may facilitate improved performance of the refractory article. The relative density may be determined as the percentage of the Archimedes bulk density relative to the theoretical density of the body. Helium pycnometry on a crushed sample may be performed to determine the theoretical density. In an example, the body may include a relative density of at most 98%, such as at most 95%, at most 93%, at most 90%, at most 89%, at most 88%, at most 87%, at most 86%, at most 85%, at most 84%, or at most 82%. In another example, the body may include a relative density of at least 78%, such as at least at least 79%, at least 80%, at least 82%, at least 83%, at least 85%, at least 88%, or at least 90%. It will be appreciated that the body may have a relative density of any value between any of the minimum and maximum values noted above. It will be further appreciated that the body may have a relative density within a range between any of the minimum and maximum values noted above.

It is worth noting that the body of embodiments herein can have improved porosity, such as increased closed porosity, decreased open porosity, uniformity of pore sizes, reduced or minimized amount of larger pores (e.g., at least 100 microns), or any combination thereof, over another body formed via a conventional forming process, such as a conventional additive manufacturing process of paste extrusion and 3D printing or isopressing.

In an embodiment, the body of the refractory article may include a particular total porosity of the total volume of the body. As used herein, the total porosity is intended to be total theoretical porosity and determined using the formula, T_{P}=1−D_{TD}, wherein T_{P} is the total porosity, and D_{TD} is the relative density. For example, the body may have a total porosity of at most 30 vol % for the total volume of the body, such as at most 29 vol %, at most 26 vol %, at most 23 vol %, at most 20 vol %, at most 19 vol %, at most 18 vol %, at most 17 vol %, at most 16 vol %, or at most 15 vol % for a total volume of the body. In another example, the body may include a total porosity of at least 1 vol % for the total volume of the body, at least 2 vol %, at least 4 vol %, at least 6 vol %, at least 8 vol %, at least 10 vol %, at least 12 vol %, at least 14 vol %, or at least 16 vol % for the total volume of the body. It will be appreciated that the body may have a total porosity of any percentage between any of the minimum and maximum values noted above. It will be further appreciated that the body may have a total porosity within a range between any of the minimum and maximum percentages noted above.

In a further embodiment, the total porosity may include interconnected pores (also referred to as “open pores”), closed pores, or any combination thereof. In an embodiment, the body may include a particular Archimedes porosity that may facilitate improved properties and performance of the refractory article. For example, the body may include Archimedes porosity of at most 16 vol %, at most 14 vol %, at most 12 vol %, at most 11 vol %, at most 9 vol %, or at most 8 vol % for the total volume of the body. In another example, the body may include Archimedes porosity of at least 1 vol % for the total volume of the body, at least 3 vol %, at least 4 vol %, at least 5 vol %, at least 6 vol %, or at least 7 vol % for the total volume of the body. Moreover, the body may include Archimedes porosity of any percentages between any of the minimum and maximum values noted above. It will be further appreciated that the body may have Archimedes porosity within a range between any of the minimum and maximum percentages noted above. Archimedes porosity may be determined based on Archimedes Principle. A skilled artisan appreciates Archimedes porosity measures interconnected porosity. As used herein, Archimedes porosity is interchangeable with open porosity.

In a further embodiment, the body may include a porosity including a particular content of closed pores that may facilitate improved properties and performance of the refractory article. In an embodiment, the body may include a closed porosity of at least 2 vol % for the total volume of the body, at least 3 vol %, at least 4 vol %, at least 5 vol %, at least 7 vol %, at least 9 vol %, or at least 12 vol % for the total volume of the body. Alternatively or additionally, the body may include a closed porosity of at most 22 vol %, at most 19 vol %, at most 16 vol %, at most 14 vol %, at most 12 vol %, at most 11 vol %, at most 9 vol %, or at most 8 vol % for the total volume of the body. Moreover, the body may include a closed porosity of any value between any of the minimum and maximum values noted above. It will be further appreciated that the body may have a closed porosity within a range between any of the minimum and maximum values noted above. As used herein, closed porosity (vol %) may be determined using the formula: Pc=T_{P}−P_{AP}, wherein Pc is closed porosity, T_{P} is the total porosity, and P_{AP} is Archimedes porosity.

In a particular embodiment, the body may include a particular percentage of the closed porosity relative to the total porosity that may facilitate improves performance of the refractory article. For example, more than 5% of the total porosity (vol %) may be closed porosity, such as at least 8%, at least 10%, at least 13%, at least 16%, at least 20%, at least 21%, at least 23%, at least 27%, at least 30%, at least 33%, at least 35%, at least 40%, at least 45%, at least 50%, at least 55%, at least 58%, at least 61%, at least 64%, at least 68%, at least 71%, at least 73%, at least 75%, or at least 77% of the total porosity (vol %) may be closed porosity. In another example, at most 95% of the total porosity (vol %) may be closed porosity, such as at most 93%, at most 91%, at most 90%, at most 88%, at most 85%, at most 83%, at most 80%, at most 75%, at most 70%, at most 67%, at most 65%, at most 60%, at most 55%, at most 53%, at most 50%, at most 46%, at most 42%, at most 38%, at most 35%, at most 31%, at most 28%, or at most 25% of the total porosity (vol %) may be closed porosity. Moreover, the percentage of closed porosity may be any percentages between any of the minimum and maximum values noted above. It will be further appreciated that the percentage of closed porosity may be within a range between any of the minimum and maximum percentages noted above.

In a particular embodiment, the body may include a particular ratio of the closed porosity to the Archimedes porosity (Pc/P_{AP}) that may facilitate improves performance of the refractory article. For example, the ratio of closed porosity to Archimedes porosity (Pc/P_{AP}) may be greater than 0.1:1, such as at least 0.2:1, at least 0.3:1, at least 0.4:1, at least 0.5:1, at least 0.6:1, at least 0.7:1, at least 0.8:1, at least 0.9:1, at least 0.9:1, at least 1:1, at least 1.1:1, at least 1.3:1, at least 1.4:1, at least 1.5:1, or at least 1.6:1. In another example, the ratio of closed porosity to Archimedes porosity (Pc/P_{AP}) may be at most 5:1, such as at most 4:1, at most 3.6:1, at most 3.3:1, at most 3:1, at most 2.5:1, at most 2.0:1, at most 1.8:1, at most 1.6:1, at most 1.3:1, at most 1:1, or at most 1:1. Moreover, the ratio of the closed porosity to the Archimedes porosity (Pc/P_{AP}) may be any ratios between any of the minimum and maximum values noted above. It will be further appreciated that the ratio of the closed porosity to the Archimedes porosity (Pc/P_{AP}) may be within a range between any of the minimum and maximum percentages noted above.

In a particular embodiment, the body may include a particular percentage of Archimedes porosity relative to the total porosity that may facilitate improves performance of the refractory article. For example, more than 1% of the total porosity (vol %) may be Archimedes porosity, such as at least 5%, at least 10%, at least 15%, at least 20%, at least 30%, at least 40%, at least 45%, at least 50%, at least 55%, at least 60%, at least 65%, or at least 70% of the total porosity (vol %) may be Archimedes porosity. In another example, at most 85% of the total porosity (vol %) may be Archimedes porosity, such as at most 80%, at most 75%, at most 70%, at most 65%, at most 62%, at most 60%, at most 58%, at most 57%, at most 56%, at most 54%, at most 53%, at most 52%, at most 48%, at most 44%, at most 41%, at most 38%, at most 35%, at most 32%, at most 28%, or at most 25% of the total porosity (vol %) may be Archimedes porosity. Moreover, the percentage of Archimedes porosity may be any percentages between any of the minimum and maximum values noted above. It will be further appreciated that the percentage of Archimedes porosity may be within a range between any of the minimum and maximum percentages noted above.

In another embodiment, the body may include a particular tortuosity that may facilitate improved performance of the refractory article.

In another embodiment, the body may include a particular permeability that may facilitate improved performance and/or properties of the body. In an embodiment, the body may include a permeability of less than 9.6 mD (milliDarcys), such as at most 9.3 mD, at most 9.2 mD, at most 8.9 mD, at most 8.8 mD, at most 8.5 mD, at most 8.3 mD, at most 8.1 mD, at most 7.8 mD, at most 7.5 mD, at most 7.3 mD, at most 7.1 mD, at most 6.6 mD, at most 6.3 mD, at most 6.1 mD, at most 5.7 mD, at most 5.4 mD, at most 5.2 mD, at most 5.0 mD, at most 4.9 mD, at most 4.6 mD, at most 4.2 mD, at most 3.9 mD, or at most 3.7 mD. Alternatively or additionally, the body may include a permeability of at least 0.5 mD, such as at least 0.8 mD, at least 1 mD, at least 1.2 mD, at least 1.3 mD, at least 1.6 mD, at least 1.7 mD, at least 2.1 mD, at least 2.4 mD, at least 2.6 mD, at least 2.9 mD, at least 3.1 mD, at least 3.4 mD, at least 3.6 mD, at least 3.9 mD, at least 4.1 mD, at least 4.3 mD, at least 4.6 mD, or at least 4.9 mD. Moreover, the body can have a permeability in a range including any of the minimum and maximum values noted herein. Permeability of the body can be measured according to the method described in Examples herein and intended to refer to an average permeability of at least 2 different bodies.

In an embodiment, the body may include a particular pore size that may facilitate improved properties and performance of the refractory article. In an embodiment, a majority of pores in the body, such as at least 51% of the total porosity (vol %) may have a diameter of at most 5 microns or less, such as at most 4 microns, at most 3 microns, at most 2 microns, or at most 1 micron.

In another embodiment, the body may have reduced or minimized number of pores having a diameter of at least 50 microns compared to a body formed by a conventional process. Larger pores, such as those having a diameter of at least 50 microns may be resulted from air bubbles entrapped in the mixture or green body during the forming process. In a further embodiment, the body may be essentially free of large pores, such as pores having a diameter of 300 microns or greater. In certain instances, the body may include a low number of pores having a diameter of at least 50 microns. In particular, in those instances, per at least 100 randomly counted different pores having the diameter of at least 50 microns, the body may include less than 15 pores having a diameter of 200 to 300 microns, such as less than 13, less than 10, less than 5, or less than 2 pores having a diameter of 200 to 300 microns as determined by analyzing microscope images of the body. In a further embodiment, the body may include at most 30% of pores having a diameter of at least 200 microns relative to the total porosity (vol %), such as at most 28%, at most 25%, at most 21%, at most 19%, at most 16%, at most 13%, at most 11%, at most 9%, at most 7%, at most 5%, at most 3%, at most 2%, or at most 1% relative to the total porosity (vol %). In a particular example, the body may be essentially free of pores having a diameter of at least 200 microns.

In an embodiment, at least 55% of the total porosity (vol %) may be constituted of pores having a diameter of at most 5 microns or less, such as at least 60%, at least 70%, at least 75%, at least 80%, at least 85%, at least 90%, or at least 93% of the total porosity (vol %) may be constituted of pores having a diameter of at most 5 microns or less than 5 microns. Additionally or alternatively, at most 95% of the total porosity (vol %) may be constituted of pores having a diameter of at most 5 microns or less, such as at most 92%, at most 90%, at most 85%, at most 82%, at most 80%, at most 75%, at most 70%, at most 65%, at most 60%, or at most 55% of the total porosity (vol %) is constituted of pores having a diameter of at most 5 microns or less.

In a particular embodiment, at least a major portion of the closed porosity may be constituted of pores having a diameter of at most 5 microns or less, such as at least 51%, at least 60%, at least 70%, at least 75%, at least 80%, at least 85%, at least 90%, or at least 93% of the closed porosity (vol %) may be constituted of pores having a diameter of at most 5 microns or less than 5 microns. Additionally or alternatively, at most 95% of the closed porosity (vol %) may be constituted of pores having a diameter of at most 5 microns or less, such as at most 92%, at most 90%, at most 85%, at most 82%, at most 80%, at most 75%, at most 70%, at most 65%, at most 60%, or at most 55% of the total porosity (vol %) may be constituted of pores having a diameter of at most 5 microns or less. In a particular example, essentially all of the closed pores may have a diameter of at most 5 microns or less.

In an embodiment, the body may include a particular average pore size, a particular pore size distribution, a particular content of closed pores having particular pore sizes, or any combination thereof. In a further embodiment, the body may comprises a median pore diameter of at most 3.6 microns, at most 3.4 microns, at most 3.1 microns, at most 2.8 microns, at most 2.6 microns, at most 2.4 microns. Alternatively or additionally, the median pore diameter may be at least 1.1 microns, at least 1.4 microns, at least 1.6 microns, at least 1.8 microns, at least 1.9 microns, or at least 2.1 microns. Moreover, the median pore size of the body may including any of the minimum and maximum values noted herein. As used herein, average pore size may be interchangeable with median pore size.

According to an embodiment, the body of the refractory article may have a particular modulus of rupture (MOR). The MOR may be measured at room temperatures (20-25° C.) using ASTM D6272. For example, the refractory article may have a body having an MOR of at least 22 MPa, at least 24 MPa, at least 27 MPa, at least 29 MPa, at least 30 MPa, at least 34 MPa, at least 37 MPa, or at least 40 MPa. In another example, the body may have an MOR of at most 50 MPa, at most 48 MPa, at most 46 MPa, at most 44 MPa, at most 42 MPa, at most 40 MPa, at most 37 MPa, at most 35 MPa, or at most 32 MPa. It will be appreciated that the refractory article may have a body having an MOR of any value between any of the minimum and maximum values noted above. It will be further appreciated that the MOR may be within a range between any of the minimum and maximum values noted above.

In a further embodiment, the refractory article of embodiments herein may have improved thermal and or mechanical properties and improved performance for intended applications. For example, the refractory article may have improved thermal shock resistance, corrosion resistance, low glass penetration, or another refractory property, or any combination thereof.

In an embodiment, the refractory article or the body thereof may have a particular thermal shock resistance as tested by thermal cycles described below. Representative refractory article samples, such as bars of 3″×1″×1″ may be tested by repeating cycles of heating the samples to 1250° C. in an oven, removing and placing the heated samples on a steel plate at room temperature. Samples are measured for the number of cycles to failure (cracking) up to a maximum of 10 cycles or higher. In a particular example, the refractory article may have a thermal shock resistance of at least 6 cycles, such as at least 7 cycles, at least 8 cycles, at least 9 cycles, or at least 10 cycles. In another example, the refractory article may have a thermal shock resistance of at most 15 cycles, at most 14 cycles, at most 13 cycles, at most 11 cycles or at most 10 cycles. It will be appreciated that the refractory article may have thermal resistance of any values between any of the minimum and maximum values noted above. It will be further appreciated that the thermal resistance may be within a range between any of the minimum and maximum values noted above.

In a further embodiment, a batch of refractory articles may include a plurality of refractory articles described in embodiments herein. In a particular embodiment, the batch may include bodies having any of the features described in embodiments herein with respect to the body of the refractory article. Any features described with values and/or percentages may be applied to the batch as average values and/or percentages of the batch. In another embodiment, a batch of refractory articles may be formed using the process described in embodiments herein. In a further embodiment, a batch of refractory articles may include at least 2 refractory articles, at least 4, at least 6, at least 8, at least 10, at least 13, at least 16, at least 20, at least 40, at least 70, at least 100, at least 500, or at least 800 refractory articles.

In an embodiment, the batch may include a particular average closed porosity that may facilitate improved performance of the batch of refractory articles. In an example, the batch may include average closed porosity of at least 2 vol % for the total volume of the batch, at least 3 vol %, at least 4 vol %, at least 5 vol %, at least 7 vol %, at least 9 vol %, at least 11 vol %, or at least 13 vol % for the total volume of the batch. In another example, the batch may comprise the average closed porosity of at most 17 vol %, at most 15 vol %, at most 14 vol %, at most 12 vol %, at most 11 vol %, at most 9 vol %, or at most 8 vol % for the total volume of the batch. Moreover, the average closed porosity of the batch may be in a range including any of the minimum and maximum percentages noted herein.

In another embodiment, the batch may comprise an average Archimedes porosity of at most 17 vol %, at most 15 vol %, at most 13 vol %, at most 12 vol %, at most 11 vol %, at most 9 vol %, or at most 8 vol % for the total volume of the batch. Alternatively or additionally, the batch may comprise an average Archimedes porosity of at least 3 vol % for the total volume of the batch, at least 4 vol %, at least 5 vol %, at least 6 vol %, at least 7 vol %, at least 9 vol %, at least 11 vol %, or at least 13 vol % for the total volume of the batch. Moreover, the average Archimedes porosity of the batch may be in a range including any of the minimum and maximum percentages noted herein.

In an embodiment, the batch may include an average closed porosity of at least 6 vol % of an average total porosity of the batch, at least 8 vol %, at least 10 vol %, at least 11 vol %, at least 13%, at least 16%, at least 20%, at least 21%, at least 23%, at least 27%, at least 30%, at least 33%, at least 35%, at least 40%, at least 45%, at least 50%, at least 55%, at least 58%, at least 61%, at least 64%, at least 68%, at least 71%, at least 73%, at least 75%, or at least 77% of the average total porosity of the batch. Alternatively or additionally, the batch may include the average closed porosity of at most 95% of the average total porosity of the batch, at most 93%, at most 91%, at most 88%, at most 85%, at most 83%, at most 80%, at most 75%, at most 70%, at most 67%, at most 65%, at most 60%, at most 55%, at most 53%, at most 50%, at most 46%, at most 42%, at most 38%, at most 35%, at most 31%, at most 28%, or at most 25% of the average total porosity of the batch. Moreover, the average closed porosity of the batch may be in a range including any of the minimum and maximum percentages noted herein.

In an embodiment, the batch may include comprises an average Archimedes porosity of at most 85%, at most 80%, at most 75%, at most 70%, at most 65%, at most 60%, at most 58%, at most 56%, at most 54%, at most 52%, at most 48%, at most 44%, at most 41%, at most 38%, at most 35%, at most 32%, at most 28%, or at most 25% of an average total porosity of the batch. Alternatively or additionally, the batch may comprise an average Archimedes porosity of at least 3 vol % for the average total porosity of the batch, at least 10%, at least 13 vol %, at least 15%, at least 20%, at least 24%, at least 25%, at least 30%, at least 35%, at least 40%, at least 45%, at least 50%, at least 55%, at least 60%, at least 65%, or at least 70% of the average total porosity (vol %) of the batch. Moreover, the average Archimedes porosity of the batch may be in a range including any of the minimum and maximum percentages noted herein.

In an embodiment, the batch may comprise an average content of pores having a diameter of at least 200 microns of at most 30% of an average total porosity (vol %) of the batch, such as at most 28%, at most 25%, at most 21%, at most 19%, at most 16%, at most 13%, at most 11%, at most 9%, at most 7%, at most 5%, at most 3%, or at most 1% of the average total porosity (vol %) of the batch. In a particular example, the batch may be essentially free of pores having a diameter of at least 200 microns.

In an embodiment, the batch may comprise an average permeability of less than 9.6 mD, at most 9.2 mD, at most 8.8 mD, at most 8.3 mD, at most 7.6 mD, at most 7.2 mD, at most 6.5 mD, at most 6.1 mD, at most 5.7 mD, at most 5.3 mD, at most 5.0 mD, at most 4.6 mD, at most 4.2 mD, at most 3.9 mD, or at most 3.7 mD. Alternatively or additionally, the batch may comprise the average permeability of at least 0.1 mD, at least 0.5 mD, at least 0.8 mD, at least 1.3 mD, at least 1.6 mD, at least 1.8 mD, at least 2.2 mD, at least 2.4 mD, or at least 2.6 mD. Moreover, the average permeability of the batch may be in a range including any of the minimum and maximum percentages noted herein.

In an embodiment, the batch may comprise an average relative density (compared to theoretical density) of at least 78%, at least 79%, at least 80%, at least 82%, at least 84%, or at least 85%. Alternatively or additionally, the batch may comprise the average relative density (compared to theoretical density) of at most 93%, at most 90%, at most 89%, at most 88%, at most 87%, at most 85%, at most 84%, or at most 82%. Moreover, the average relative density (compared to theoretical density) may be in a range including any of the minimum and maximum percentages noted herein.

In an embodiment, the batch may comprise average MOR of at least 22 MPa, at least 24 MPa, at least 27 MPa, at least 29 MPa, at least 30 MPa, at least 34 MPa, at least 37 MPa, or at least 40 MPa. Alternatively or additionally, the batch may comprise the average MOR of at most 50 MPa, at most 48 MPa, at most 46 MPa, at most 44 MPa, at most 42 MPa, at most 40 MPa, at most 37 MPa, at most 35 MPa, or at most 32 MPa. Moreover, the average MOR of the batch may be in a range including any of the minimum and maximum percentages noted herein. In another embodiment, the batch may comprise a thermal shock resistance of at least 6 cycles, at least 7 cycles, at least 8 cycles, at least 9 cycles, or at least 10 cycles.

In an embodiment, the batch may comprise an average total porosity of at most 30 vol % for a total volume of the batch, such as at most 29 vol %, at most 26 vol %, at most 23 vol %, at most 21 vol %, at most 19 vol %, at most 18 vol %, at most 17 vol %, at most 16 vol %, or at most 15 vol % for the total volume of the batch. Alternatively or additionally, the batch may comprise a total porosity of at least 1 vol % for the total volume of the batch, at least 3 vol %, at least 8 vol %, at least 10 vol %, at least 12 vol %, at least 14 vol %, or at least 16 vol % for the total volume of the batch. Moreover, the average total porosity of the batch may be in a range including any of the minimum and maximum percentages noted herein.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A refractory article, comprising a body comprising:
a ceramic material including an oxide; and
a total porosity of at most 30 vol % for a total volume of the body, wherein pores having a diameter of at least 200 microns is at most 30% of the total porosity; and
at least one of closed pores of at least 8 vol % of the total porosity and permeability of less than 9.6 mD,
wherein the body further comprises:
Modulus of Rupture (MOR) of at least 20 MPa;
a thermal shock resistance of at least 6 cycles; or
any combination thereof.

Embodiment 2. A refractory article, comprising a body comprising:
a ceramic material including an oxide;
a total porosity of at most 30 vol % for a total volume of the body, wherein closed pores are at least 8% of the total porosity; and
at least one of a relative density of at least 78% and open pores of at most 16 vol % for a total volume of the body,
wherein the body further comprises:
Modulus of Rupture (MOR) of at least 20 MPa;
a thermal shock resistance of at least 6 cycles; or
any combination thereof.

Embodiment 3. The refractory article of embodiment 1 or 2, wherein the ceramic material comprises a metal oxide; and/or wherein the ceramic material consists essentially of one or more metal oxides; and/or wherein the ceramic material comprises chromium oxide, mullite, alumina, zircon, zirconium oxide, or any combination thereof.

Embodiment 4. The refractory article of any one of embodiments 1 to 3, wherein the body comprises a primary constituent comprising an oxide including chromium oxide, mullite, alumina, zircon, or zirconium oxide.

Embodiment 5. The refractory article of embodiment 4, wherein the primary constituent is in a content of at least 50 wt. % for a total weight of the body, at least 55 wt. %, at least 60 wt. %, at least 65 wt. %, at least 70 wt. %, at least 75 wt. %, at least 80 wt. %, at least 85 wt. %, at least 85 wt. %, at least 90 wt. %, at least 92 wt. %, at least 95 wt. %, or at least 98 wt. % for the total weight of the body; and/or wherein the primary constituent may be at most 99.5 wt. % for the total weight of the body, at most 99 wt. %, at most 98 wt. %, at most 95 wt. %, at most 93 wt. %, at most 90 wt. %, at most 85 wt. %, at most 80 wt. %, at least 75 wt. %, at most 70 wt. %, at most 65 wt. %, at most 60 wt. %, or at most 55 wt. % for the total weight of the body.

Embodiment 6. The refractory article of any one of embodiments 1 to 5, wherein the body comprises an additive including titanium oxide, zirconium oxide, magnesium oxide, or any combination thereof.

Embodiment 7. The refractory article of embodiment 6, wherein the additive is at least 0.5 wt. % for a total weight of the body, at least 1 wt. %, at least 2 wt. %, or at least 4 wt. % for the total weight of the body; and/or wherein the additive is at most 5 wt. % for the total weight of the body, at most 4 wt. %, at most 3 wt. %, at most 2 wt. %, at most 1 wt. %, or at most 0.5 wt. % for the total weight of the body.

Embodiment 8. The refractory article of any one of embodiments 1 to 7, wherein the body comprises a primary constituent including chromium oxide, wherein the body optionally includes an additive including zirconia, titania, magnesia, or a combination thereof.

Embodiment 9. The refractory article of any one of embodiments 1 to 8, wherein the body comprises a primary constituent of chromium oxide and one or more oxides selected from titanium oxide, zirconium oxide, zircon, or any combination thereof, wherein the content of chromium oxide is at least 55 wt. % for the total weight of the body, at least 60 wt. %, at least 65 wt. %, at least 70 wt. %, at least 75 wt. %, at least 80 wt. %, or at least 90 wt. % for the total weight of the body; and/or wherein the content of chromium oxide is at most 98 wt. % for the total weight of the body, at most 95 wt. %, at most 90 wt. %, at most 85 wt. %, at most 80 wt. %, at most 75 wt. %, at most 70 wt. %, or at most 65 wt. % for the total weight of the body.

Embodiment 10. The refractory article of any one of embodiments 1 to 8, wherein the body comprises a primary constituent of zircon and one or more oxides selected from titanium oxide, zirconium oxide, chromium oxide, or any combination thereof, wherein the content of zircon is at least 55 wt. % for the total weight of the body, at least 60 wt. %, at least 65 wt. %, at least 70 wt. %, at least 75 wt. %, at least 80 wt. %, or at least 90 wt. % for the total weight of the body; and/or wherein the content of zircon is at most 98 wt. % for the total weight of the body, at most 95 wt. %, at most 90 wt. %, at most 85 wt. %, at most 80 wt. %, at most 75 wt. %, at most 70 wt. %, or at most 65 wt. % for the total weight of the body.

Embodiment 11. The refractory article of any one of embodiments 1 to 10, wherein the body comprises a total porosity of at most 30 vol % for a total volume of the body, at most 29 vol %, at most 26 vol %, at most 23 vol %, at most 21 vol %, at most 19 vol %, at most 18 vol %, at most 17 vol %, at most 16 vol %, or at most 15 vol % for a total volume of the body; and/or wherein the body comprises a total porosity of at least 1 vol % for the total volume of the body, at least 3 vol %, at least 8 vol %, at least 10 vol %, at least 12 vol %, at least 14 vol %, or at least 16 vol % for the total volume of the body.

Embodiment 12. The refractory article of any one of embodiments 1 to 11, wherein the closed pores are at least 2 vol % for the total volume of the body, at least 3 vol %, at least 4 vol %, at least 5 vol %, at least 7 vol %, at least 9 vol %, or at least 12 vol % for the total volume of the body; and/or wherein the body comprises a closed porosity of at most 22 vol %, at most 19 vol %, at most 16 vol %, at most 14 vol %, at most 12 vol %, at most 11 vol %, at most 9 vol %, or at most 8 vol % for the total volume of the body.

Embodiment 13. The refractory article of any one of embodiments 1 to 12, wherein the open pores are at most 16 vol %, at most 14 vol %, at most 12 vol %, at most 11 vol %, at most 9 vol %, or at most 8 vol % for the total volume of the body; and/or wherein the open pores are at least 1 vol % for the total volume of the body, at least 3 vol %, at least 4 vol %, at least 5 vol %, at least 6 vol %, or at least 7 vol % for the total volume of the body.

Embodiment 14. The refractory article of any one of embodiments 1 to 13, wherein a majority of pores have a diameter of at most 5 microns, at most 4 microns, at most 3 microns, at most 2 microns, or at most 1 micron in diameter; and/or wherein at least 55% of the total porosity (vol %) is constituted of pores having a diameter of at most 5 microns or less than 5 microns, at least 60%, at least 70%, at least 75%, at least 80%, at least 85%, at least 90%, or at least 93% of the total porosity (vol %) is constituted of pores having a diameter of at most 5 microns or less than 5 microns; and/or wherein the body comprises a median pore diameter of at most 3.6 microns, at most 3.4 microns, at most 3.1 microns, at most 2.8 microns, at most 2.6 microns, at most 2.4 microns; and/or wherein the median pore diameter is at least 1.1 microns, at least 1.4 microns, at least 1.6 microns, at least 1.8 microns, at least 1.9 microns, or at least 2.1 microns.

Embodiment 15. The refractory article of any one of embodiments 1 to 14, wherein the body is essentially free of pores having a diameter of 300 microns or greater.

Embodiment 16. The refractory article of any one of embodiments 1 to 15, wherein the body comprises Archimedes Bulk density of at least 3.8 g/cm³, at least 3.9 g/cm³, at least 4.0 g/cm³, at least 4.2 g/cm³, or at least 4.3 g/cm³; and/or wherein the body comprises Archimedes Bulk density of at most 4.7 g/cm³, at most 4.5 g/cm³, at most 4.4 g/cm³, or at most 4.3 g/cm³; and/or wherein the body comprises a relative density (compared to theoretical density) of at least 78%, at least 79%, at least 80%, at least 82%, at least 84%, or at least 85%; and/or wherein the body comprises a relative density (compared to theoretical density) of at most 93%, at most 90%, at most 89%, at most 88%, at most 87%, at most 85%, at most 84%, or at most 82%.

Embodiment 17. The refractory article of any one of embodiments 1 to 16, wherein the body comprises MOR of at least 22 MPa, at least 24 MPa, at least 27 MPa, at least 29 MPa, at least 30 MPa, at least 34 MPa, at least 37 MPa, or at least 40 MPa; and/or wherein the body comprises MOR of at most 50 MPa, at most 48 MPa, at most 46 MPa, at most 44 MPa, at most 42 MPa, at most 40 MPa, at most 37 MPa, at most 35 MPa, or at most 32 MPa.

Embodiment 18. The refractory article of any one of embodiments 1 to 17, wherein the body comprises a thermal shock resistance of at least 6 cycles, at least 7 cycles, at least 8 cycles, at least 9 cycles, or at least 10 cycles.

Embodiment 19. The refractory article of any one of embodiments 1 to 18, wherein the closed porosity is at least 8% of the total porosity (vol %) of the body, at least 10%, at least 13%, at least 16%, at least 20%, at least 21%, at least 23%, at least 27%, at least 30%, at least 33%, at least 35%, at least 40%, at least 45%, at least 50%, at least 55%, at least 58%, at least 61%, at least 64%, at least 68%, at least 71%, at least 73%, at least 75%, or at least 77% of the total porosity of the body; and/or wherein the closed porosity is at most 95% of the total porosity of the body, at most 93%, at most 91%, at most 88%, at most 85%, at most 83%, at most 80%, at most 75%, at most 70%, at most 67%, at most 65%, at most 60%, at most 55%, at most 53%, at most 50%, at most 46%, at most 42%, at most 38%, at most 35%, at most 31%, at most 28%, or at most 25% of the total porosity of the body.

Embodiment 20. The refractory article of any one of embodiments 1 to 19, wherein the body comprises open porosity of at least 10% of the total porosity (vol %) of the body, at least 15%, at least 20%, at least 24%, at least 25%, at least 30%, at least 35%, at least 40%, at least 45%, at least 50%, at least 55%, at least 60%, at least 65%, or at least 70% of the total porosity (vol %) of the body; and/or wherein the body comprises Archimedes porosity of at most 85%, at most 80%, at most 75%, at most 70%, at most 65%, at most 60%, at most 58%, at most 56%, at most 54%, at most 52%, at most 48%, at most 44%, at most 41%, at most 38%, at most 35%, at most 32%, at most 28%, or at most 25% of the total porosity (vol %) of the body.

Embodiment 21. A process for forming a refractory article, comprising:
forming a mixture including an inorganic material including one or more metal oxides, an organic material including a binder material of at least 5 vol % for a total volume of the mixture, a dispersant, and a solvent, wherein the mixture comprises a solid loading of the inorganic material at least 67 vol % and less than 75 vol % for a total volume of the mixture; and
forming a green body including a plurality of layers from the mixture.

Embodiment 22. The process of embodiment 21, wherein forming the green body comprises extruding and/or printing using at least a portion of the mixture to form the plurality of layers.

Embodiment 23. The process of embodiment 21 or 22, comprising moving the mixture through a barrel containing a screw having an L/D ratio at least or greater than 8, a compression ratio greater than 1, or any combination thereof.

Embodiment 24. The process of any one of embodiments 21 to 23, wherein the solid loading is at least 55 vol % for a total volume of the mixture, at least 58 vol %, at least 62 vol %, at least 65 vol %, at least 68 vol %, at least 70 vol %, at least 72 vol %, or at least 74 vol % for the total volume of the mixture; and/or wherein the solid loading is less than 75 vol %, at most 74 vol %, at most 73 vol %, or at most 72 vol % for the total volume of the mixture.

Embodiment 25. The process of any one of embodiments 21 to 24, wherein the mixture comprises a viscosity of at least 10 Pa·S to at most 1000 Pa·S at a shear rate from 1 s−1 to 100 s−1 or at least 10 Pa·S to at most 800 Pa·S or at least 10 Pa·S to at most 500 Pa·S or at least 20 Pa·S to at most 500 Pa·S.

Embodiment 26. The process of any one of embodiments 21 to 25, wherein the mixture comprises a viscosity at a shear rate of 1 s−1 of at least 20 Pa·S, at least 30 Pa·S, at least 50 Pa·S, at least 60 Pa·S, at least 70 Pa·S, at least 80 Pa·S, at least 90 Pa·S, or at least 100 Pa·S; and/wherein the mixture comprises a viscosity at a shear rate of 1 s−1 of at most 1000 Pa·S, at most 900 Pa·S, at most 800 Pa·S, at most 700 Pa·S, at most 600 Pa·S, or at most 500 Pa·S.

Embodiment 27. The process of any one of embodiments 21 to 26, wherein the mixture comprises a viscosity at a shear rate of 10 s−1 of at least 10 Pa·S, at least 15 Pa·S, at least 20 Pa·S, at least 25 Pa·S, at least 30 Pa·S, at least 35 Pa·S, at least 40 Pa·S, or at least 45 Pa·S; and/wherein the mixture comprises a viscosity at a shear rate of 10 s−1 of at most 500 Pa·S, at most 400 Pa·S, at most 300 Pa·S, at most 200 Pa·S, at most 100 Pa·S, at most 90 Pa·S, or at most 80 Pa·S.

Embodiment 28. The process of any one of embodiments 21 to 27, wherein the mixture comprises a viscosity at a shear rate of 100 s⁻¹ of at least 10 Pa·S, at least 15 Pa·S, at least 20 Pa·S, at least 25 Pa·S, or at least 30 Pa·S; and/wherein the mixture comprises a viscosity at a shear rate of 100 s⁻¹ of at most 100 Pa·S, at most 90 Pa·S, at most 80 Pa·S, at most 70 Pa·S, at most 50 Pa·S, at most 40 Pa·S, or at most 30 Pa·S.

Embodiment 29. The process of any one of embodiments 21 to 28, wherein the green body has a porosity of at least 20 vol % to at most 35 vol % for the total volume of the green body.

Embodiment 30. The process of any one of embodiments 21 to 29, wherein the metal oxide comprises chromium oxide, titanium oxide, zircon, zirconium oxide, or any combination thereof.

Embodiment 31. The process of any one of embodiments 21 to 30, wherein the binder material is at least 2.5 vol % of a binder material for the total volume of the mixture, such as at least 2.7 vol %, at least 3.2 vol %, at least 3.5 vol %, at least 3.8 vol %, at least 4.0 vol %, at least 4.3 vol %, at least 4.6 vol %, at least 4.8 vol %, at least 5.0 vol %, at least 5.2 vol %, at least 5.5 vol %, at least 5.8 vol %, at least 6.0 vol %, at least 6.3 vol %, or at least 6.5 vol % for the total volume of the mixture; and/or wherein the binder material is at most 8.0 vol % for the total volume of the mixture, such as at most 7.7 vol %, at most 7.5 vol %, at most 7.3 vol %, at most 7.0 vol %, at most 6.7 vol %, or at most 6.5 vol %.

Embodiment 32. The process of any one of embodiments 21 to 31, wherein the binder material comprises polyvinyl alcohol, polyethylene glycol, or any combination thereof.

Embodiment 33. The process of any one of embodiments 21 to 32, wherein the dispersant is at least 2.0 vol % of dispersant for the total volume of the mixture, such as at least 2.4 vol %, at least 2.8 vol %, at least 3.2 vol %, at least 3.5 vol %, at least 3.8 vol %, at least 4.0 vol %, at least 4.3 vol %, at least 4.6 vol %, at least 4.8 vol %, at least 5.0 vol %, at least 5.2 vol %, or at least 5.5 vol % for the total volume of the mixture; and/or wherein the dispersant is at most 7.0 vol % for the total volume of the mixture, such as at most 6.7 vol %, at most 6.5 vol %, at most 6.3 vol %, at most 6.0 vol %, at most 5.7 vol %, or at most 5.5 vol %.

Embodiment 34. The process of any one of embodiments 21 to 33, wherein the dispersant comprises polycarboxylate-based dispersing agent.

Embodiment 35. The process of any one of embodiments 21 to 34, wherein the solvent comprises water, ethanol, isopropyl alcohol, or any combination thereof.

Embodiment 36. The process of any one of embodiments 21 to 35, wherein forming the green body comprises a printing speed of 100 to 1000 mm/min.

Embodiment 37. The process of any one of embodiments 21 to 36, wherein forming the green body comprises an extrusion pressure of 0.2 to 0.8 MPa, a holding torque of 3.0 Nm, or any combination thereof.

Embodiment 38. The process of any one of embodiments 21 to 37, wherein forming the green body comprises monitoring humidity, and/or wherein forming the green body is performed at humidity of at most 40%.

Embodiment 39. The process of any one of embodiments 21 to 38, wherein forming the mixture comprises mixing with a high shear mixing device.

Embodiment 40. The process of any one of embodiments 21 to 39, wherein forming the mixture comprises a stirring speed of 4 to 80 rpm, horse power of 1 to 4, or a rotating speed of 4 to 69 rpm.

Embodiment 41. The process of any one of embodiments 21 to 40, wherein the green body is rectilinear, cylindrical, spherical, or ellipsoidal.

Embodiment 42. The process of any one of embodiments 21 to 41, wherein the green body has a shape of a prism block, a flow block or a bushing block; and/or wherein the body comprises an aperture that extends through at least a portion of the body.

Embodiment 43. The process of any one of embodiments 21 to 42, wherein the green body comprises at least one dimension of at least 100 mm, at least 200 mm, at least 300 mm, at least 400 mm, at least 500 mm, at least 600 mm, at least 700 mm, or at least 800 mm.

Embodiment 44. The process of any one of embodiments 21 to 43, further comprising heating the green body to form a finally-formed body, wherein heating is conducted at a temperature from 1400° C. to 1700° C.

Embodiment 45. The process of embodiment 44, wherein the finally-formed body has a linear shrinkage of at most 25%, at most 20%, or at most 18% compared to the green body.

Embodiment 46. The process of any one of embodiments 21 to 45, wherein the green body is a stand-alone, defect-free, crack-free, or any combination thereof.

Embodiment 47. The process of any one of embodiments 21 to 40, wherein the mixture is in the form of a paste.

Embodiment 48. The process of any one of embodiments 21 to 47, wherein the process comprises paste extrusion additive manufacturing, 3D printing, or any combination thereof.

Embodiment 49. A process, comprising using a refractory article in manufacturing glass, wherein the refractory article comprises a forming block, a bushing block, or both, and wherein the refractory article is made by using additive manufacture and comprises a property including a property comprising Modulus of Rupture (MOR) of at least 20 MPa; a thermal shock resistance of at least 6 cycles; or any combination thereof.

Embodiment 50. A batch of refractory articles, comprising a plurality of the refractory articles of embodiment 1, wherein the batch comprises an average closed porosity of at least 2 vol % for the total volume of the batch, at least 3 vol %, at least 4 vol %, at least 5 vol %, at least 7 vol %, at least 9 vol %, at least 11 vol %, or at least 13 vol % for the total volume of the batch; and/or wherein the batch comprises the average closed porosity of at most 17 vol %, at most 15 vol %, at most 14 vol %, at most 12 vol %, at most 11 vol %, at most 9 vol %, or at most 8 vol % for the total volume of the batch.

Embodiment 51. The batch of refractory articles of embodiment 50, wherein the batch comprises an average Archimedes porosity of at most 17 vol %, at most 15 vol %, at most 13 vol %, at most 12 vol %, at most 11 vol %, at most 9 vol %, or at most 8 vol % for the total volume of the batch; and/or wherein the batch comprises an average Archimedes porosity of at least 3 vol % for the total volume of the batch, at least 4 vol %, at least 5 vol %, at least 6 vol %, at least 7 vol %, at least 9 vol %, at least 11 vol %, or at least 13 vol % for the total volume of the batch.

Embodiment 52. A process, comprising using the refractory article of embodiment 1, wherein the refractory article is placed in an environment comprising a temperature of at least 1200° C., in contact with molten glass, or any combination thereof.

Embodiment 53. The batch of refractory articles of any one of embodiments 50 to 52, comprising an average closed porosity of at least 6 vol % of an average total porosity of the batch, at least 8 vol %, at least 10 vol %, at least 11 vol %, at least 13%, at least 16%, at least 20%, at least 21%, at least 23%, at least 27%, at least 30%, at least 33%, at least 35%, at least 40%, at least 45%, at least 50%, at least 55%, at least 58%, at least 61%, at least 64%, at least 68%, at least 71%, at least 73%, at least 75%, or at least 77% of the average total porosity of the batch; and/or wherein the batch comprises the average closed porosity of at most 95% of the average total porosity of the batch, at most 93%, at most 91%, at most 88%, at most 85%, at most 83%, at most 80%, at most 75%, at most 70%, at most 67%, at most 65%, at most 60%, at most 55%, at most 53%, at most 50%, at most 46%, at most 42%, at most 38%, at most 35%, at most 31%, at most 28%, or at most 25% of the average total porosity of the batch.

Embodiment 54. The batch of refractory articles of any one of embodiments 50 to 52, wherein the batch comprises an average Archimedes porosity of at most 85%, at most 80%, at most 75%, at most 70%, at most 65%, at most 60%, at most 58%, at most 56%, at most 54%, at most 52%, at most 48%, at most 44%, at most 41%, at most 38%, at most 35%, at most 32%, at most 28%, or at most 25% of an average total porosity of the batch; and/or wherein the batch comprises an average Archimedes porosity of at least 3 vol % for the average total porosity of the batch, at least 10%, at least 13 vol %, at least 15%, at least 20%, at least 24%, at least 25%, at least 30%, at least 35%, at least 40%, at least 45%, at least 50%, at least 55%, at least 60%, at least 65%, or at least 70% of the average total porosity (vol %) of the batch.

Embodiment 55. The batch of refractory articles of any one of embodiments 50 to 52, wherein the batch comprises an average content of pores having a diameter of at least 200 microns of at most 30% of an average total porosity (vol %) of the batch, at most 28%, at most 25%, at most 21%, at most 19%, at most 16%, at most 13%, at most 11%, at most 9%, at most 7%, at most 5%, at most 3%, or at most 1% of the average total porosity (vol %) of the batch; and/or wherein the batch is essentially free of pores having a diameter of at least 200 microns.

Embodiment 56. The batch of refractory articles of any one of embodiments 50 to 52, wherein the batch comprises an average permeability of less than 9.6 mD, at most 9.2 mD, at most 8.8 mD, at most 8.3 mD, at most 7.6 mD, at most 7.2 mD, at most 6.5 mD, at most 6.1 mD, at most 5.7 mD, at most 5.3 mD, at most 5.0 mD, at most 4.6 mD, at most 4.2 mD, at most 3.9 mD, or at most 3.7 mD; and/or wherein the average permeability of the batch is at least 0.1 mD, at least 0.5 mD, at least 0.8 mD, at least 1.3 mD, at least 1.6 mD, at least 1.8 mD, at least 2.2 mD, at least 2.4 mD, or at least 2.6 mD.

Embodiment 57. The batch of refractory articles of any one of embodiments 50 to 52, wherein the batch comprises an average relative density (compared to theoretical density) of at least 78%, at least 79%, at least 80%, at least 82%, at least 84%, or at least 85%; and/or wherein the batch comprises the average relative density (compared to theoretical density) of at most 93%, at most 90%, at most 89%, at most 88%, at most 87%, at most 85%, at most 84%, or at most 82%.

Embodiment 58. The batch of refractory articles of any one of embodiments 50 to 52, wherein the batch comprises average MOR of at least 22 MPa, at least 24 MPa, at least 27 MPa, at least 29 MPa, at least 30 MPa, at least 34 MPa, at least 37 MPa, or at least 40 MPa; and/or wherein the batch comprises average MOR of at most 50 MPa, at most 48 MPa, at most 46 MPa, at most 44 MPa, at most 42 MPa, at most 40 MPa, at most 37 MPa, at most 35 MPa, or at most 32 MPa.

Embodiment 59. The batch of refractory articles of any one of embodiments 50 to 52, wherein the batch comprises a thermal shock resistance of at least 6 cycles, at least 7 cycles, at least 8 cycles, at least 9 cycles, or at least 10 cycles.

Embodiment 60. The batch of refractory articles of any one of embodiments 50 to 52, wherein the batch comprises an average total porosity of at most 30 vol % for a total volume of the batch, at most 29 vol %, at most 26 vol %, at most 23 vol %, at most 21 vol %, at most 19 vol %, at most 18 vol %, at most 17 vol %, at most 16 vol %, or at most 15 vol % for the total volume of the batch; and/or wherein the batch comprises a total porosity of at least 1 vol % for the total volume of the batch, at least 3 vol %, at least 8 vol %, at least 10 vol %, at least 12 vol %, at least 14 vol %, or at least 16 vol % for the total volume of the batch.

Embodiment 61. The batch of refractory articles of any one of embodiments 50 to 52, wherein the batch comprises at least 5 refractory articles, at least 8, at least 10, at least 20, at least 50, at least 70, at least 100, at least 500, or at least 800 refractory articles.

Embodiment 62. The refractory article of embodiment 1 or 2, wherein the body comprises pores having a diameter of at least 200 microns of at most 30% of the total porosity (vol %) of the body, at most 28%, at most 25%, at most 21%, at most 19%, at most 16%, at most 13%, at most 11%, at most 9%, at most 7%, at most 5%, at most 3%, or at most 1% of the total porosity (vol %) of the body; and/or wherein the body is essentially free of pores having a diameter of at least 200 microns.

Embodiment 63. The refractory article of embodiment 1 or 2, wherein the body comprises a permeability of less than 9.6 mD, at most 9.2 mD, at most 8.8 mD, at most 8.3 mD, at most 7.6 mD, at most 7.2 mD, at most 6.5 mD, at most 6.1 mD, at most 5.7 mD, at most 5.3 mD, at most 5.0 mD, at most 4.6 mD, at most 4.2 mD, at most 3.9 mD, or at most 3.7 mD; and/or wherein the permeability of the body is at least 0.1 mD, at least 0.5 mD, at least 0.8 mD, at least 1.3 mD, at least 1.6 mD, at least 1.8 mD, at least 2.2 mD, at least 2.4 mD, or at least 2.6 mD.

### EXAMPLES

### Example 1

Paste samples S1 are prepared having the composition noted in Table 1 according to embodiments described herein and formed into green bodies according to embodiments described herein.

In brief, a pre-mixture of the dispersant and water may be prepared and mixed with another pre-mixture of the binder and chromia material using a high shear mixer.

TABLE 1

| | Samples |
|---|---|
| Composition (vol %) | S1 |
| Chromia powder | 72 |
| (including up to 98 | |
| wt. % chromia and | |
| additives of TiO2 and | |
| ZrO2) | |
| polycarboxylate- | 5.5 |
| based Dispersant | |
| Binder (PVA) | 6.5 |
| Water | 16 |

Viscosity of Samples S1 is evaluated as described in embodiments herein and illustrated in FIG. 4. At the shear rates from 5 s⁻¹, the samples have viscosity of approximately 40-250 Pa·S, and at the shear rate of −20 s⁻¹, the viscosity reduced to approximately 30-200 Pa·S. Sample S1 demonstrates shear thinning behavior.

Paste Samples CS4 are prepared in the similar manner having the compositions noted in Table 2.

TABLE 2

| | Samples |
|---|---|
| Composition (vol %) | CS4 |
| Chromia powder | 68 |
| (including up to 98 | |
| wt. % chromia and | |
| additives of TiO2 and | |
| ZrO2) | |
| polycarboxylate- | 5.2 |
| based Dispersant | |
| Viscosity modifier | 1 |
| (Methocel A4M) | |
| Water | 25.8 |

Samples CS4 were prepared utilizing a viscosity modifier, Methocel A4M, instead of the binder, and it is noted that the solid loading of the samples could not reach higher than 68 vol %.

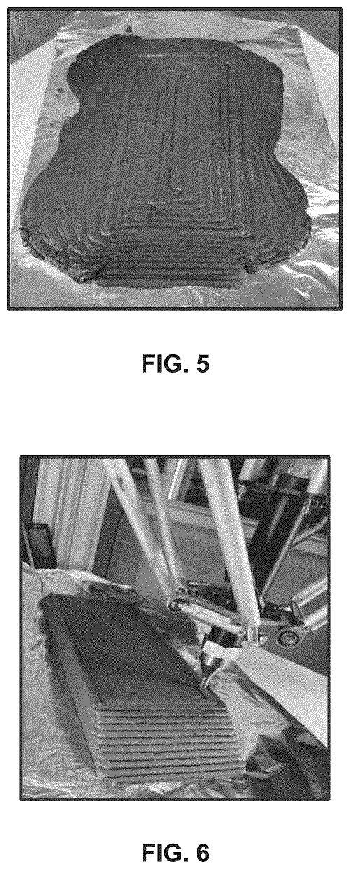

Paste samples S1 and CS4 are processed using Delta WASP 40100 clay printer with the original screw having the L/D ratio of 8 and compression ratio of 1.0. The nozzle size is 6 mm. Sample S1 is used to form the green body S2 and Sample CS4 is used to form the green body CS5. As illustrated in FIG. 5 slumping can be observed for the green body CS5. The structure of the green body S2 is well maintained while and after printing (FIG. 6). After drying, the green body S2 has not any crack formation.

### Example 2

The green body S2 is sintered as described in embodiments herein forming the refractory sample S8.

Another portion of paste Samples S1 is processed to form the green body S3, using Delta WASP 40100 clay printer that is modified with a custom-designed screw having the L/D ratio of 8 and compression ratio of 1.7. The structure of the green body S3 is well maintained while and after printing. The green body S3 is sintered to form a refractory sample S9 in the same manner as described for forming Sample S8. Parameters for forming the green body S3 is included in Table 3.

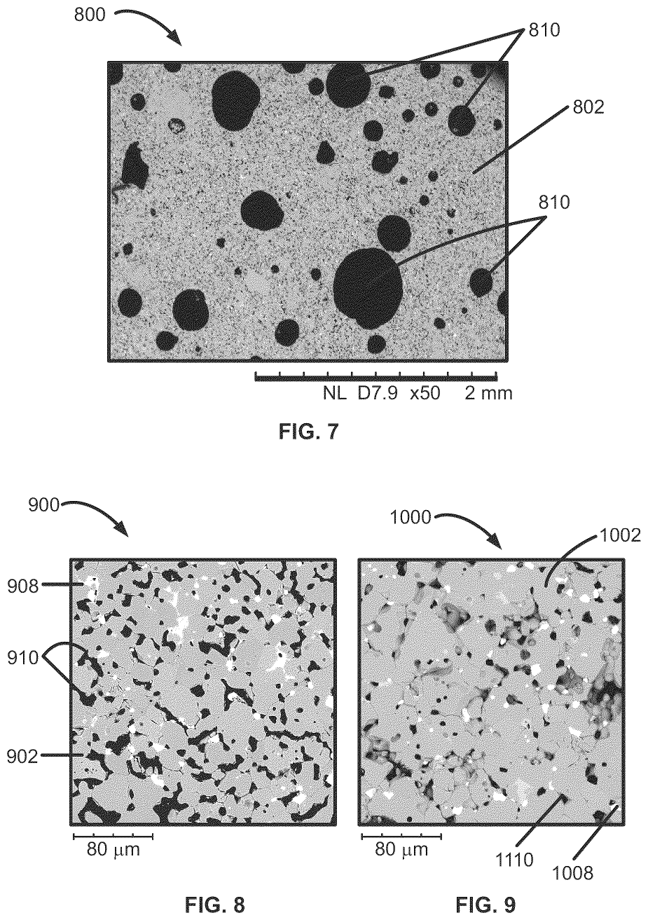

Samples S8 and S9 and additional samples noted in Example 3 are evaluated for certain properties and porosity as described in embodiments herein and results are noted in Table 4 below Example 3. A microscope image of a cross section of Sample S8 is included in FIG. 7. The body 800 of Sample S8 includes a primary phase 802 including chromia and pores 810 resulted from air bubbles. The pores 810 have diameters spanning from approximately 100 microns to greater than 300 microns.

TABLE 3

| Parameters | |
|---|---|
| Holding Torque (Nm) | 3.0 |
| Printing speed | 250 |
| (mm/min) | |
| Humidity | 40% |
| Temperature | Room temperature |

Samples S8 and S9 are to be used as bushing blocks in fiberglass manufacturing and tested for corrosion resistance. Sample S9 is expected to have improved performance over S8.

### Example 3

A refractory Sample CS11 is formed by using wet bag cold isostatic pressing (CIP) as following. The mixture of ceramic fillers and additives for forming the composition noted below is gravity-fed into a perforated can that contains a flexible rubber bag. The steel can helps shape the mixture and give the mixture a structure. The rubber bag is sealed with essentially a rubber cap/stopper and evacuated. The entire assembly is placed in a pressure vessel where water is used to apply 10,000 to 30,000 psi of hydrostatic pressure to the flexible rubber bag, compacting the solids. The bag is removed and the pressed green body is then sintered.

Both Sample CS 11 and S9 include chromia of approximately 98 wt. % and a total content of ZrO2 and TiO2 of approximately 2 wt. % for the total weight of their respective bodies. FIG. 8 includes a microscope image of a cross section of the body 900 of Sample CS11. The body 900 includes pores 910 having irregular shapes, a primary phase 902 including chromia, and a secondary phase 908 including ZrO2. Nearly all pores 910 are interconnected pores. Sample S9 includes a body 1000 including pores 1110, a primary phase 1002 including chromia, and a secondary phase 1008 including ZrO2 (FIG. 9). A significant amount of pores 1110 are closed pores. Samples CS11 and S9 are to be used as bushing blocks in fiberglass manufacturing. Samples CS11 and S9 were tested for corrosion resistance using the method described below.

A glass penetration test was performed on Samples CS11 and S9. A well of the same size was drilled out each of the samples, and 4 g of glass was put in the well. The samples were then placed in a furnace at 1450° C. for 8 hours. FIGS. 15A and 15B include illustrations of images of the samples taken after heating in the furnace. Wells 1512 and 1592 were made in the bodies 1510 and 1590 of Samples CS11 and S9, respectively. It was observed that nearly all glass penetrated into the body of CS11, and no glass visibly remained in the well 1512, while a significant amount of glass was in the well 1592, indicating reduced penetration in Sample S9 compared to CS11. The samples were then cut through the wells and the glass penetration depth was measured. Glass penetration depth in Sample CS11 was 6.3 mm and 3.7 mm in Sample S9. An additional sample, Sample S10 was made in the same manner having the same composition as Sample S9 and was tested for glass penetration depth using the same method described herein. Similar to Sample S9, a significant amount of glass remained in the well after heating in the furnace, and the glass penetration depth was 2.4 mm. Samples S9 and S10 demonstrate improved resistance against glass penetration and are expected to have reduced corrosion as bushing blocks in glass manufacturing.

Samples S8-S10 and CS11 are evaluated for certain properties that are summarized in Table 4.

TABLE 4

| Sample | CS11 | S8 | S9 &S10 |
|---|---|---|---|
| Thermal shock | 10 cycles | 6.2 cycles | 10 cycles |
| resistance | | | |
| MOR (MPa) | 35 | 25 | 27 |
| Archimedes Bulk | 4.32 | 3.99 | 4.18-4.33 |
| Density (g/cm³) | | | |
| Relative density | 83% | 77% | 80-84% |
| (relative to the | | | |
| density of chromia) | | | |
| Archimedes porosity | 15.9 | 18.9 | 4-13 |
| (vol %) | | | |
| Total porosity (vol %) | 16.9 | 23.3 | 16-20 |
| Closed porosity (vol %) | 1.1 | 4.4 | 7-13 |
| Median pore size | 3.74 | to be tested | 2-2.5 |
| (microns) | | | |
| Permeability (mD) | 9.6 | to be tested | 2-5 |
| Percentage of pores of | 0 | 59 | 0 |
| 200 microns or greater | | | |
| from image analysis | | | |
| (vol %) | | | |

Thermal shock resistance of the samples was tested according to embodiments herein. Maximum of 10 cycles were tested on all samples except for those that failed at an earlier cycle. The number of cycles the samples survived is included in Table 4.

### Example 4

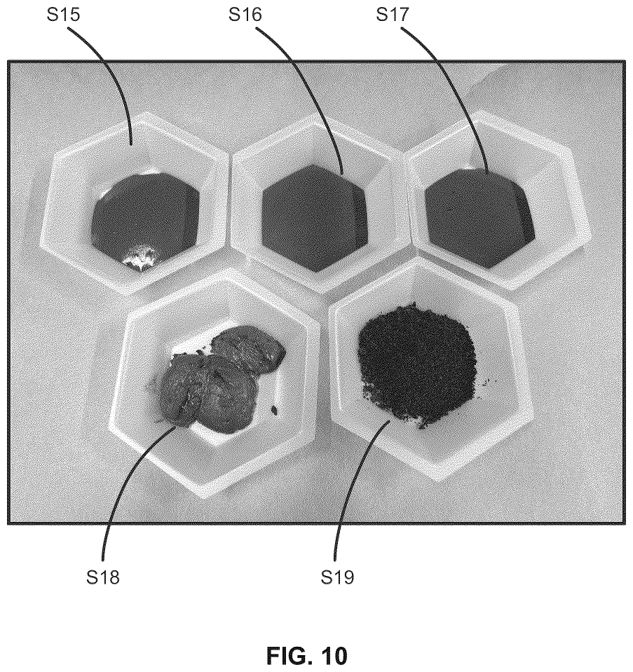

Paste samples S15-S19 having different solid loadings are made. Images of the paste samples are illustrated in FIG. 10 and compositions are included in Table 5. Samples S15-S17 appear uniform mixtures while uniform pastes were not formed for Samples S18 and S19. It is to be appreciated that the total contents of all the components are 100 vol % for the samples even though some ranges are provide.

TABLE 5

| Composition | Samples | | | | |
|---|---|---|---|---|---|
| (vol %) | S15 | S16 | S17 | S18 | S19 |
| Chromia powder | 70 | 71 | 72 | 76 | 78 |
| (including up to | | | | | |
| 98 wt. % | | | | | |
| chromia and | | | | | |
| additives of | | | | | |
| TiO2 and ZrO2) | | | | | |
| polycarboxylate- | 5.3 | 5.4 | 5.5 | 5.3-6.5 | 5.3-6.5 |
| based | | | | | |
| Dispersant | | | | | |
| Binder (PVA) | 5.3 | 6.4 | 6.5 | 6.3-7.5 | 6.3-7.5 |
| Water | 18.4 | 17.2 | 16 | 14-17.4 | 14-17.4 |

### Example 5

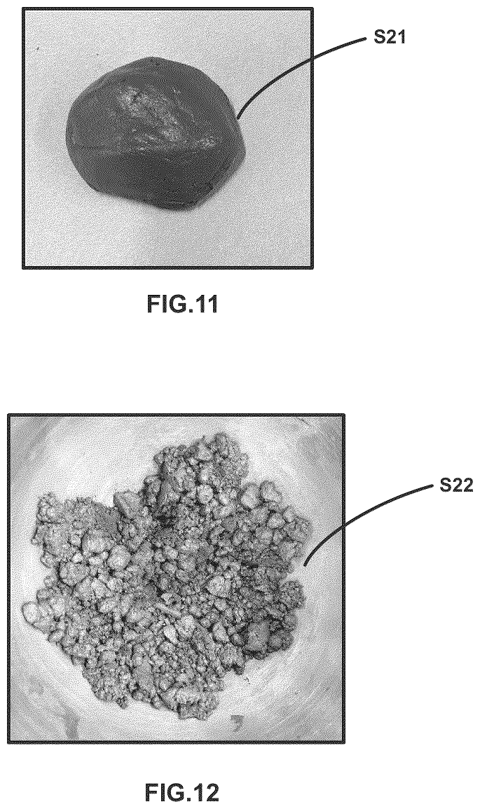

Paste samples having the same compositions as S1 are prepared using different mixing devices. Sample S21 is prepared using Flackteck speed mixer while Sample S22 is prepared using Hobart mixer. As illustrated in FIG. 11, Sample S21 demonstrates good consistency with little slump. As illustrated in FIG. 12, Sample S22 demonstrates poor consistency, and there may be a higher possibility of incorporation of air bubbles inside the paste.

### Example 6

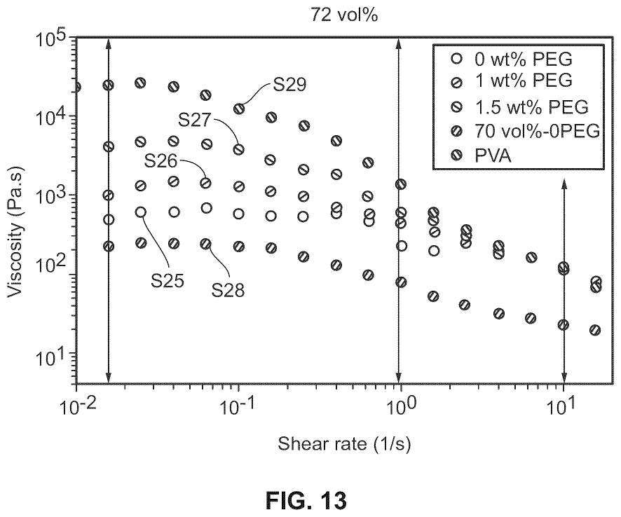

Paste Samples are prepared in similar manner as described in Example 1 with respect to Sample S1. Table 6 summarizes the composition of the Paste samples, and FIG. 13 includes a plot of shear rates vs. viscosity of the samples.

TABLE 6

| | Samples | | | | |
|---|---|---|---|---|---|
| Composition | S25 | S26 | S27 | S28 | S29 |
| Chromia powder | 72 | 72 | 72 | 70 | 72 |
| (vol %) | | | | | |
| (including up to | | | | | |
| 98 wt. % | | | | | |
| chromia and | | | | | |
| additives of | | | | | |
| TiO2 and ZrO2) | | | | | |
| polycarboxylate- | 5.5 | 5.5 | 5.5 | 5.3 | 5.5 |
| based | | | | | |
| Dispersant | | | | | |
| Binder | / | 1 wt. % | 1.5 wt. % | / | 6.5 |
| | | PEG8000 | PEG8000 | | vol % |
| | | | | | PVA |
| Water (vol %) | 22.5 | | | 24.7 | 16 |
| Total (vol %) | 100 | 100 | 100 | 100 | 100 |

Sample S28 has no binder and lowest solid loading. As illustrated in FIG. 13, Sample S28 has the viscosity of approximately 210 Pa·S, which is lower than the other samples at the shear rate of approximately 0.017 s⁻¹ and from 180 to 50 Pa·S at the shear rates from 1 to 10 s⁻¹. Sample S25 has no binder and the solid loading of 72 vol %. As illustrated in FIG. 13, Sample S25 has the viscosity of approximately 460 Pa·S, which is lower than Samples S26-S27 and S29 at the shear rate of approximately 0.017 s⁻¹ and from 360 to 250 Pa·S at the shear rates from 1 to 1.5 s⁻¹. Samples S25 and S28 do not demonstrate a shear thinning behavior.

Sample S29 appear to have the highest viscosity at the shear rates from approximately 0.017 s⁻¹ to 1 s⁻¹. The viscosity decreases significantly as the shear rates increases from 1 to 10 s⁻¹.

Samples S27 and S26 demonstrate increased viscosity compared to Samples S25 and S28 from approximately 0.017 s⁻¹ to 1 s⁻¹. The viscosity of both samples starts to decrease quickly as the shear rate exceeds 1 s⁻¹ and appear similar to the viscosity of S29 as the shear rate increases to 10 s⁻¹. Sample S27 appears to have improved viscosity at shear rates less than 1 s⁻¹ and shear thinning behavior at the shear rates from 1 to 10 s⁻¹ compared to Sample S26.

The data suggests that PEG8000 may be a suitable binder material for making a paste for extrusion, as it increases viscosity of the paste at low shear rates 0.017 s⁻¹ to 1 s⁻¹, which may help hold structure shape of the green body. PEG8000 also helps to improve shear thinning which may facilitate extrusion of the paste.

### Example 7

A paste sample S20 having 74 vol % of solid loading is prepared using PVA. The sample could not be extruded using Delta WASP 40100 clay printer with the original screw.

Sample S20 can be properly extruded and printed to form a green body without defect, using Delta WASP 40100 clay printer modified to have the screw having the L/D ratio of 8 and compression ratio of 1.7.

### Example 8

A block sample S31 is made in the same manner as described for forming sample S9. Another block sample CS32 having similar dimensions is made via conventional iso-pressing using the same chromia powder for making S31. Sample S31 has a density of 3.95 g/cm3 and porosity of 19.04 vol %. Sample CS32 has a density of 4.30 g/cm3 and porosity of 15.8 vol %.

A glass penetration test is conducted on both Samples S31 and CS32. Glass of 4 g is placed into a well drilled out of Samples S31 and CS32, respectively. Then the samples are placed in a furnace at 1450° C. for 8 hours, and the glass penetration depth is measured. Glass penetration forms a darker-colored ring around the well perimeter, and the diameter of the ring is measured. By cutting through the centers of the wells, the center depth of glass penetration is also measured. Sample S31 demonstrates 20-30% decreases in glass penetration laterally and vertically compared to Sample CS32. The data suggests that Sample S31 has potential to reduce the glass penetration into the refractory block and can potentially reduce the corrosion compared to Sample CS32. Not wishing to be bound to any theory, reductions in glass penetration may be facilitated by reduced open porosity in Sample S31 compared to Sample CS32.

### Example 9

Permeability (in milliDarcys, mD) and the effective pore length (L) are measured in a group of samples S33 that are formed in a similar manner as Sample 31 and another group of conventional iso-pressed samples CS34. As noted in Table 7 below, Samples S33, compared to Sample CS34, has smaller permeability (5 to 7 vs. 9.6 mD) and less effective pore length (2.1 vs. 2.9 microns), which suggests less glass diffusion for Sample S33 compared to Sample CS34.

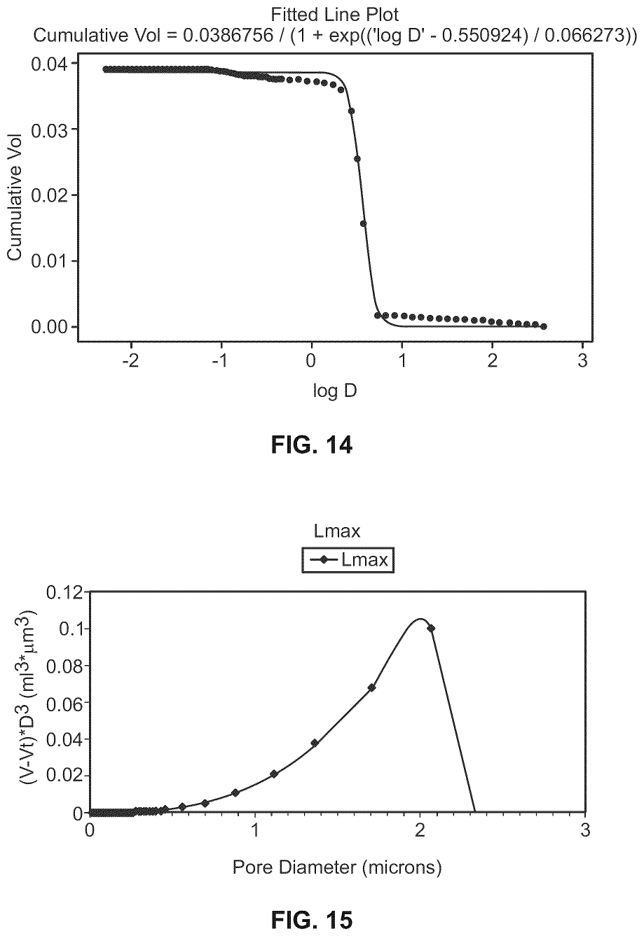

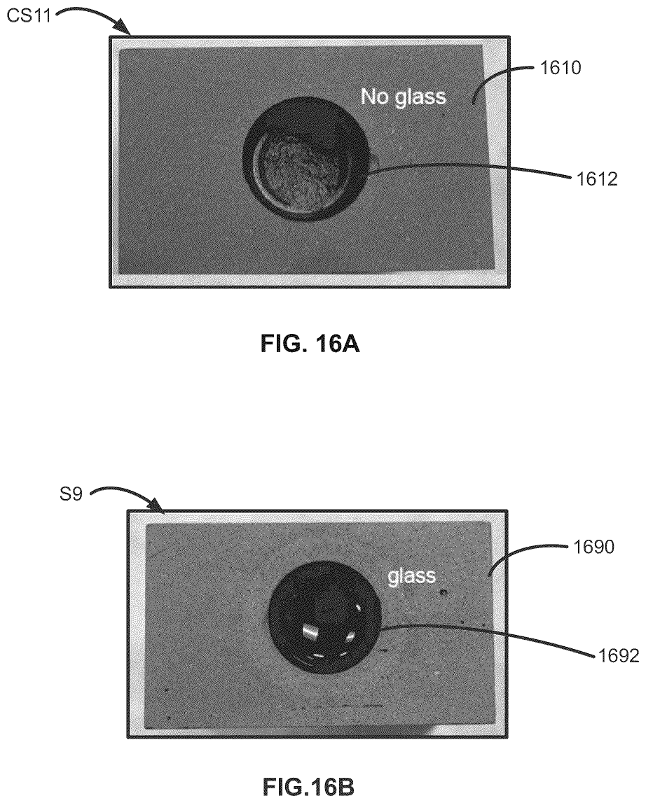

Permeability and effective pore length is determined as follows using mercury intrusion porosimetry. Mercury is forced into the open pore volume of a sample. Pressure is increased in steps from ambient to over 30,000 psi and the volume of mercury entering the sample is precisely measured at each step. The result is a tabulation of mercury volume intrusion (V) with pressure (P), and the diameter of pores entered is related to the pressure by the equation D=−4γ cos θ/P, where γ is surface tension of mercury and θ is the wetting angle of mercury on the sample material. This allows tabulation of mercury penetration volume against pore diameter. The curve of Specific volume intrusion (SVI=volume/mass, (M)) vs. log₁₀ D is sigmoidal as shown in FIG. 14 and can be described by SVI=A/(1+exp((log₁₀D−Dₒ)/B)), giving constants A, B, and Dₒ. The value Dₒ is the location of the inflection point in the V vs. log₁₀ D curve. L_{c}=Dₒ is a characteristic pore dimension. Vₜ is the mercury intrusion volume at the inflection point, L_{c}=Dₒ, of the curve. Vₜ is equal to A/2. We can now plot (V−Vₜ) D³ against D. The maximum on this curve gives Lₘₐₓ, or a “maximum” or mode pore dimension that contributes the largest proportion of pore volume, as shown in FIG. 15. Parameter S(Lₘₐₓ) is equal to Vₘₐₓ/Vₜₒₜₐₗ, where Vmax is the volume at Lₘₐₓ. φ is the volumetric porosity, which can be calculated from the total intrusion and the sample weight and density. Permeability (k) of the sample can be determined using the formula, k=Lₘₐₓ³φS(Lₘₐₓ)/(89 L_{c}). Lₘₐₓ is used as effective pore length L herein.

Note that not all of the activities described above in the general description or the examples are required, that a portion of a specific activity may not be required, and that one or more further activities may be performed in addition to those described. Still further, the orders in which activities are listed are not necessarily the order in which they are performed. Any values of properties or characteristics of the embodiments herein can represent average or median values derived from a statistically relevant sample size. Unless otherwise stated, it will be appreciated that compositions are based on a total of 100% and the total content of the components does not exceed 100%.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, and may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A refractory article, comprising a body comprising:
a ceramic material including an oxide; and
a total porosity of at most 30 vol % for a total volume of the body, wherein pores having a diameter of at least 200 microns is at most 30% of the total porosity; and
at least one of closed porosity of at least 8% of the total porosity (vol %) and permeability of less than 9.6 mD,
wherein the body further comprises:
Modulus of Rupture (MOR) of at least 20 MPa;
a thermal shock resistance of at least 6 cycles; or
any combination thereof.

2. The refractory article of claim 1, wherein the closed porosity of the body is at least 2 vol % and at most 22 vol % for the total volume of the body.

3. The refractory article of claim 1, wherein the body comprises open porosity of at most 16 vol % for the total volume of the body.

4. The refractory article of claim 1, wherein the ceramic material comprises one or more metal oxides.

5. The refractory article of claim 1, wherein the ceramic material comprises chromium oxide, mullite, alumina, zircon, zirconium oxide, or any combination thereof.

6. The refractory article of claim 1, wherein a majority of pores in the body have a diameter of at most 5 microns.

7. The refractory article of claim 1, wherein the body is essentially free of pores having a diameter of 300 microns or greater.

8. The refractory article of claim 1, wherein the body comprises Archimedes Bulk density of at least 3.8 g/cm³ and at most 4.7 g/cm³.

9. The refractory article of claim 1, wherein the closed porosity is at least 21% of the total porosity of the body.

10. The refractory article of claim 1, wherein the body comprises open porosity of at most 68% relative to the total porosity (vol %) of the body.

11. A refractory article, comprising a body comprising:
a ceramic material including an oxide;
a total porosity of at most 30 vol % for a total volume of the body, wherein closed porosity are at least 8% of the total porosity; and
at least one of a relative density of at least 78% and open porosity of at most 16 vol % for a total volume of the body,
wherein the body further comprises:
Modulus of Rupture (MOR) of at least 20 MPa;
a thermal shock resistance of at least 6 cycles; or
any combination thereof.

12. The refractory article of claim 11, wherein the body comprises a primary constituent comprising an oxide including chromium oxide, mullite, alumina, zircon, or zirconium oxide.

13. The refractory article of claim 11, wherein the total porosity is at most 26 vol % and at least 1 vol % for a total volume of the body.

14. The refractory article of claim 11, wherein at least 55% of the total porosity (vol %) is constituted of pores having a diameter of at most 5 microns.

15. The refractory article of claim 11, wherein the body comprises a relative density of at least 78% and at most 93%.

16. The refractory article of claim 11, wherein the refractory article comprises a forming block, a bushing block, or both.

17. A batch of refractory articles, comprising a plurality of the refractory articles of claim 11, wherein the batch comprises average open porosity of at most 17 vol % for a total volume of the batch or at most 65% relative to average total porosity of the batch.

18. A process for forming a refractory article, comprising:
forming a mixture including an inorganic material including one or more metal oxides, wherein the mixture comprises a solid loading of the inorganic material at least 67 vol % and less than 75 vol % for a total volume of the mixture; and
forming a green body including a plurality of layers from the mixture, wherein forming comprises moving the mixture through a barrel containing a screw having an L/D ratio of greater than 8, a compression ratio greater than 1, or any combination thereof.

19. The process of claim 18, wherein the process comprises paste extrusion additive manufacturing, 3D printing, or any combination thereof.

20. The process of claim 18, wherein the green body has a shape of a prism block, a flow block or a bushing block.
